(19) United States
(12) Patent Application Publication
(10) Pub. No.: US 2025/0104633 A1
(43) Pub. Date: Mar. 27, 2025

(54) PIXEL AND DISPLAY APPARATUS INCLUDING THE SAME

(71) Applicant: Samsung Display Co., Ltd., Yongin-si (KR)

(72) Inventors: Sanghyun Kang, Yongin-si (KR); Ohchul Kwon, Yongin-si (KR); Byungkwan Song, Yongin-si (KR); Joosun Yoon, Yongin-si (KR); Sangmyoung Lee, Yongin-si (KR); Jaehoon Lee, Yongin-si (KR); Joon Huh, Yongin-si (KR)

(73) Assignee: Samsung Display Co., Ltd., Yongin-si (KR)

(21) Appl. No.: 18/891,176

(22) Filed: Sep. 20, 2024

(30) Foreign Application Priority Data
Sep. 25, 2023 (KR) 10-2023-0128493

(51) Int. Cl. G09G 3/3233

(52) U.S. Cl. CPC G09G 3/3233; G09G 2300/0426; G09G 2300/0819; G09G 2300/0852; G09G 2300/0861; G09G 2320/0233; G09G 2320/0247

(57) ABSTRACT

A pixel includes a light-emitting element, a first transistor connected between a first voltage line and the light-emitting element, a second transistor connected between the first voltage line and the first transistor, a third transistor connected between the first transistor and the light-emitting element, and a fourth transistor connected between the light-emitting element and a second voltage line, wherein the pixel is configured to emit light in a plurality of emission periods between a plurality of non-emission periods during one frame, and the second transistor is turned off and the third transistor is turned on in even-numbered non-emission periods among the plurality of non-emission periods.

### CROSS-REFERENCE TO RELATED APPLICATION(S)

This application claims priority to Korean Patent Application No. 10-2023-0128493 under 35 U.S.C. § 119, filed on Sep. 25, 2023, in the Korean Intellectual Property Office, the entire contents of which are incorporated herein by reference.

### BACKGROUND

### 1. Technical Field

One or more embodiments relate to a pixel and a display apparatus including the pixel.

### 2. Description of the Related Art

Recently, the usage of display apparatuses has diversified. As display apparatuses have become thinner and more lightweight, their usage is gradually widening.

As a display apparatus is variously utilized, there are various methods of designing the shape of a display apparatus, and functions that are combined or associated with a display apparatus have increased.

### SUMMARY

One or more embodiments include a display apparatus capable of improving display quality. However, such a technical objective is just an example, and embodiments are not limited thereto.

Additional aspects will be set forth in part in the description which follows and, in part, will be apparent from the description, or may be learned by practice of the embodiments.

According to one or more embodiments, a pixel may include a light-emitting element, a first transistor connected between a first voltage line and the light-emitting element, a second transistor connected between the first voltage line and the first transistor, a third transistor connected between the first transistor and the light-emitting element, and a fourth transistor connected between the light-emitting element and a second voltage line. The pixel may be configured to emit light in a plurality of emission periods between a plurality of non-emission periods during one frame, and the second transistor may be turned off and the third transistor may be turned on in even-numbered non-emission periods among the plurality of non-emission periods.

The pixel may be configured to emit light in at least four emission periods during one frame, the first transistor may be a driving transistor, the second transistor may be a first emission control transistor, the third transistor may be a second emission control transistor, and the fourth transistor may be a reset transistor.

The fourth transistor may be turned on in odd-numbered non-emission periods among the plurality of non-emission periods, and a period in which the fourth transistor is turned on in each of the odd-numbered non-emission periods other than a first non-emission period may be greater than a period in which the fourth transistor is turned on in the first non-emission period among the odd-numbered non-emission periods.

The second transistor may be turned off, and the third transistor may be turned on in a portion of a period in which the fourth transistor is turned on during each of the odd-numbered non-emission periods.

During periods other than the first non-emission period among the odd-numbered non-emission periods, after the third transistor switches from a turned-on state to a turned-off state, the fourth transistor may switch from a turned-off state to a turned-on state.

The first non-emission period may include a write-period in which a data signal is supplied to the pixel, a first period in which the fourth transistor is turned on before the write-period, and a second period in which the fourth transistor is turned on after the write-period, and the second transistor may be turned off and the third transistor may be turned on during a portion of the second period.

The second transistor may be turned off and the third transistor may be turned on during the first period.

The pixel may further include a fifth transistor connected between a third voltage line and a gate of the first transistor, wherein the first non-emission period may further include a third period between the first period and the write-period, and the fifth transistor may be turned on during the first period and the third period.

The second transistor may be turned on and the third transistor may be turned off during the third period.

The pixel may further include a first capacitor connected between a gate of the first transistor, and a node to which the first transistor and the third transistor are connected, and a second capacitor connected between the first voltage line and the node.

According to one or more embodiments, a display apparatus may include a plurality of pixels, and a driving circuit that outputs gate signals to the plurality of pixels. Each of the plurality of pixels includes a light-emitting element, a first transistor connected between a first voltage line and the light-emitting element, a second transistor connected between the first voltage line and the first transistor, a third transistor connected between the first transistor and the light-emitting element, and a fourth transistor connected between the light-emitting element and a second voltage line. The pixel may be configured to emit light in a plurality of emission periods between a plurality of non-emission periods during one frame. The driving circuit may be configured to output a first gate signal of a gate-off voltage to the second transistor, and output a second gate signal of a gate-on voltage to the third transistor in even-numbered non-emission periods among the plurality of non-emission periods.

The plurality of pixels may be configured to emit light in at least four emission periods during one frame, the first transistor may be a driving transistor, the second transistor may be a first emission control transistor, the third transistor may be a second emission control transistor, and the fourth transistor may be a reset transistor.

The driving circuit may be configured to output a third gate signal of a gate-on voltage to the fourth transistor in odd-numbered non-emission periods among the plurality of non-emission periods, and a period in which the third gate signal is a gate-on voltage in each of the odd-numbered non-emission periods other than a first non-emission period may be greater than a period in which the third gate signal is a gate-on voltage in the first non-emission period among the odd-numbered non-emission periods.

The driving circuit may be configured to output a first gate signal of a gate-off voltage and a second gate signal of a gate-on voltage in a portion of a period in which the third gate signal is a gate-on voltage during each of the odd-numbered non-emission periods.

The driving circuit may be configured to, during periods other than the first non-emission period among the odd-numbered non-emission periods, transition the second gate signal from a gate-on voltage to a gate-off voltage and output the second gate signal, and then transition the third gate signal from a gate-off voltage to a gate-on voltage and output the third gate signal.

The first non-emission period may include a write-period in which a data signal is supplied to the plurality of pixels, a first period in which the third gate signal is a gate-on voltage before the write-period, and a second period in which the third gate signal is a gate-on voltage after the write-period, and the driving circuit may be configured to output a first gate signal of a gate-off voltage and a second gate signal of a gate-on voltage, in a portion of the second period.

The driving circuit may be configured to output a first gate signal of a gate-off voltage and a second gate signal of a gate-on voltage during the first period.

Each of the pixels may further include a fifth transistor connected between a third voltage line and a gate of the first transistor, wherein the first non-emission period may further include a third period between the first period and the write-period, and the driving circuit may be configured to output a fourth gate signal of a gate-on voltage to the fifth transistor during the first period and the third period.

The driving circuit may be configured to output a first gate signal of a gate-on voltage and a second gate signal of a gate-off voltage during the third period.

The driving circuit may be configured to change a period in which the first gate signal is a gate-on voltage and a period in which the first gate signal is a gate-off voltage based to an emission ratio.

According to one or more embodiments, a method for driving the display apparatus comprises turning on a fourth transistor in odd-numbered non-emission periods among a plurality of non-emission periods, wherein a period in which the fourth transistor is turned on in each of the odd-numbered non-emission periods other than a first non-emission period is greater than a period in which the fourth transistor is turned on in the first non-emission period among the odd-numbered non-emission periods. The method further comprises that a second transistor is turned off and a third transistor is turned on in a portion of a period in which the fourth transistor is turned on during each of the odd-numbered non-emission periods. During periods other than the first non-emission period among the odd-numbered non-emission periods the method further comprises: after a third transistor switches from a turned-on state to a turned-off state, the fourth transistor switches from a turned-off state to a turned-on state.

In a preferred implementation of the method, the first non-emission period includes: turning on the fourth transistor, turning off the second transistor and turning on the third transistor during a first period; then supplying a data signal to the pixel in a write-period subsequent to the first period; and then turning on the fourth transistor in a second period subsequent to the writing period, and during a portion of the second period: turning off the second transistor and turning on the third transistor.

### BRIEF DESCRIPTION OF THE DRAWINGS

The above and other aspects, features, and advantages of certain embodiments will be more apparent from the following description taken in conjunction with the accompanying drawings, in which:

FIGS. 1A and 1B are schematic views of a display apparatus according to an embodiment;

FIG. 2 is a schematic view of a display apparatus according to an embodiment;

FIGS. 3A and 3B are schematic views for explaining a method of driving a display apparatus according to driving frequencies;

FIG. 4 is a schematic diagram of an equivalent circuit of a pixel according to an embodiment;

FIG. 5 is a view of signals supplied to a pixel during a first scan period according to an embodiment;

FIG. 6 is an enlarged view of a portion of the first scan period of FIG. 5;

FIG. 7 is a view of signals supplied to a pixel during a second scan period according to an embodiment;

FIGS. 8 and 9 are views of signals supplied to a pixel during a first scan period and a second scan period, according to a comparative example;

FIG. 10 is a view showing a flicker characteristic difference for each frequency in case that the pixel shown in FIG. 4 operates according to a comparative example;

FIG. 11 is a view showing a driving voltage change in case that the pixel shown in FIG. 4 operates according to a comparative example;

FIG. 12 is a view showing a flicker characteristic difference for each frequency in case that the pixel shown in FIG. 4 operates according to an embodiment;

FIG. 13 is a view showing a brightness change in a portion of an image in case that the pixel shown in FIG. 4 operates according to an embodiment and a comparative example;

FIG. 14A is a view showing a mura occurring in a portion of an image according to a comparative example;

FIG. 14B is a view showing an improved image according to an embodiment;

FIG. 15 is a view of signals supplied to a pixel during a first scan period according to an embodiment;

FIG. 16 is a view of signals supplied to a pixel during a second scan period according to an embodiment;

FIG. 17 is a schematic cross-sectional view of a structure of a display element according to an embodiment;

FIGS. 18A, 18B, 18C, 18D, 19A, and 19B are schematic cross-sectional views of a structure of a display element according to an embodiment; and

FIG. 20 is a schematic cross-sectional view of a structure of a pixel of a display apparatus according to an embodiment.

### DETAILED DESCRIPTION OF THE EMBODIMENTS

Reference will now be made in detail to embodiments, examples of which are illustrated in the accompanying drawings, wherein like reference numerals refer to like elements throughout. In this regard, the embodiments may have different forms and should not be construed as being limited to the descriptions set forth herein. Accordingly, the embodiments are merely described below, by referring to the figures, to explain aspects of the description. As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

As the disclosure allows for various changes and numerous embodiments, certain embodiments will be illustrated in the drawings and described in the written description. Effects and features of the disclosure, and methods for achieving them will be clarified with reference to embodiments described below in detail with reference to the drawings. However, the disclosure is not limited to the following embodiments and may be embodied in various forms.

While such terms as “first” and “second” may be used to describe various elements, such elements must not be limited to the above terms. The above terms are used to distinguish one element from another.

The singular forms “a,” “an,” and “the” as used herein are intended to include the plural forms as well unless the context clearly indicates otherwise.

It will be understood that the terms “comprise,” “comprising,” “include” and/or “including” as used herein specify the presence of stated features or elements but do not preclude the addition of one or more other features or elements.

It will be further understood that, when a layer, region, or element is referred to as being “on” another layer, region, or element, it can be directly or indirectly on the other layer, region, or element. For example, intervening layers, regions, or elements may be present.

Sizes of elements in the drawings may be exaggerated or reduced for convenience of explanation. As an example, the size and thickness of each element shown in the drawings are arbitrarily represented for convenience of description, and thus, the disclosure is not necessarily limited thereto.

In the specification, “A and/or B” means A or B, or A and B. In the specification, “at least one of A and B” means A or B, or A and B.

In embodiments below, when it is described that X is connected to Y, X may be electrically connected to Y, X may be functionally connected to Y, or X may be physically connected to Y, with or without at least one intervening element. Here, X and Y may be objects (e.g., apparatuses, elements, circuits, wirings, electrodes, terminals, conductive layers, layers, and the like). Accordingly, X and Y are not limited to preset connection relationships and connection relationships shown and made in the drawings and the detailed description, but may include connection relationships other than the connection relationships shown and made in the drawings and the detailed description.

The case where X is electrically connected to Y may include a case where X and Y are electrically connected or directly connected and a case where at least one element (e.g., a switch, a transistor, a capacitance element, an inductor, a resistance element, a diode, and the like) enabling electrical connection between X and Y is connected between X and Y.

In embodiments below, “ON” used in association with an element state may denote an active state of an element, and “OFF” may denote an inactive state of an element. “ON” used in association with a signal received by an element may denote a signal activating the element, and “OFF” may denote a signal inactivating the element. An element may be activated by a high-level voltage or a low-level voltage. As an example, a P-channel transistor (e.g., a P-type transistor) may be activated by a low-level voltage, and an N-channel transistor (e.g., an N-type transistor) may be activated by a high-level voltage. Accordingly, it should be understood that “ON” voltages for a P-type transistor and an N-type transistor are opposite (low vs. high) voltage levels.

In embodiments below, an x-axis direction, a y-axis direction, and a z-axis direction are not limited to directions along three axes of the rectangular coordinate system, and may be interpreted in a broader sense. For example, the x-axis direction, the y-axis direction, and the z-axis direction may be perpendicular to one another, or may represent different orientations that are not perpendicular to one another.

A display apparatus according to embodiments may be used as a display screen of various products including televisions, notebook computers, monitors, advertisement boards, Internet of things (IoTs) as well as portable electronic apparatuses including mobile phones, smartphones, tablet personal computers (PCs), mobile communication terminals, electronic organizers, electronic books, portable multimedia players (PMPs), navigations, and ultra mobile personal computers (UMPCs). For example, the display apparatus according to an embodiment may be used in wearable devices including smartwatches, watchphones, glasses-type displays, and head-mounted displays (HMD). For example, in an embodiment, the display apparatus 1 is applicable to a display screen in instrument panels for automobiles, center fascias for automobiles, or center information displays (CIDs) arranged on a dashboard, room mirror displays that replace side mirrors of automobiles, and displays of an entertainment system arranged on the backside of front seats for backseat passengers in automobiles. For example, a display apparatus may be a flexible apparatus.

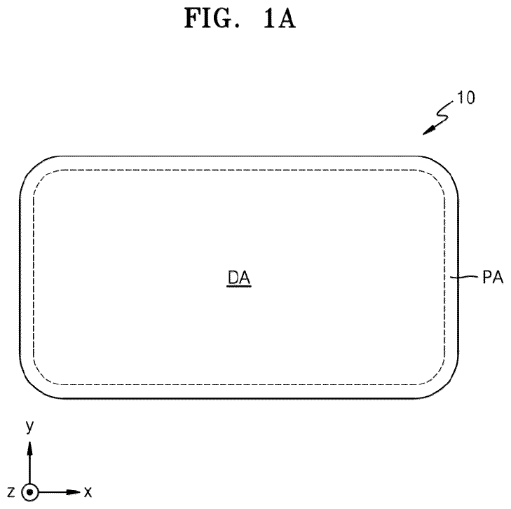

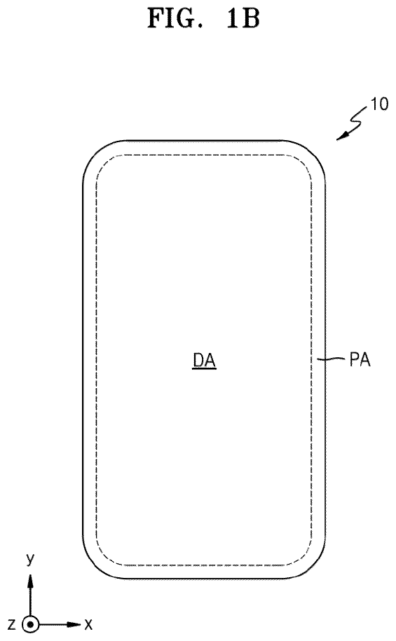

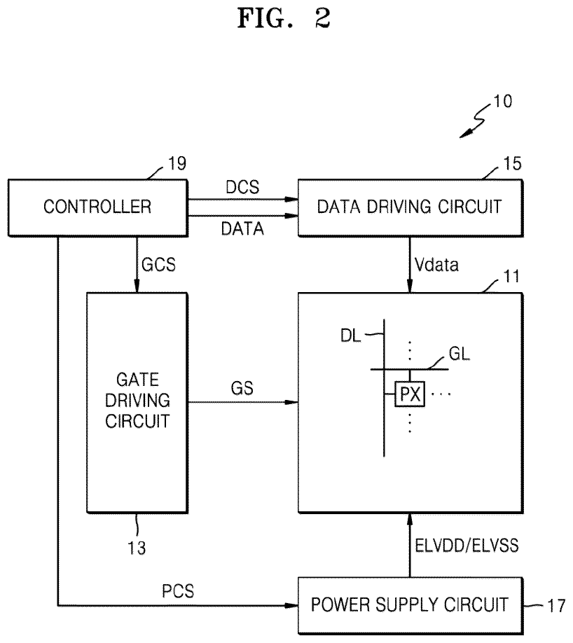

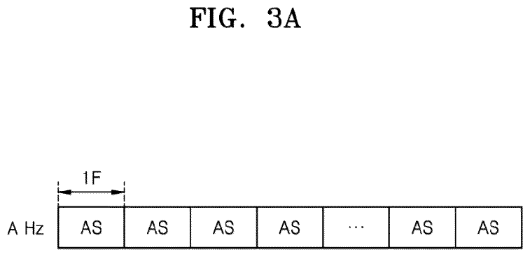

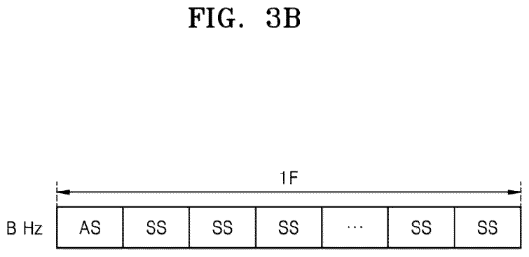

FIGS. 1A and 1B are schematic views of a display apparatus 10 according to an embodiment. FIG. 2 is a schematic view of the display apparatus 10 according to an embodiment. FIGS. 3A and 3B are schematic views for explaining a method of driving the display apparatus 10 according to driving frequencies.

Referring to FIGS. 1A and 1B, the display apparatus 10 may include a display area DA that displays images and a peripheral area PA outside the display area DA. The display area DA may be surrounded (e.g., entirely surrounded) by the peripheral area PA.

In a plan view, the display area DA may have a rectangular shape. In another embodiment, the display area DA may have a polygonal shape such as a triangle, a pentagon, a hexagon, and the like, a circular shape, an elliptical shape, an irregular shape, or the like. The corner portion of the edge portion of the display area DA may have a round shape. In an embodiment, the display apparatus 10 may have the display area DA of a shape in which a length in an x-axis direction is greater than a length in a y-axis direction as shown in FIG. 1A. In another embodiment, the display apparatus 10 may have the display area DA of a shape in which a length in the y-axis direction is greater than a length in the x-axis direction as shown in FIG. 1B. A z-axis direction may be substantially perpendicular to a plane defined by the x-axis direction and the y-axis direction.

Referring to FIG. 2, the display apparatus 10 according to an embodiment may include a pixel area 11, a gate driving circuit 13, a data driving circuit 15, a power supply circuit 17, and a controller 19.

The pixel area 11 may be disposed in the display area DA. Various conductive lines for transferring electrical signals to be applied to the display area DA, outer circuits electrically connected to pixel circuits, and pads to which a printed circuit board or a driver integrated circuit (IC) chip is attached may be positioned in the peripheral area PA. As an example, the gate driving circuit 13, the data driving circuit 15, the power supply circuit 17, and the controller 19 may be disposed in the peripheral area PA.

As shown in FIG. 2, gate lines GL, data lines DL, and pixels PX connected thereto may be arranged in the display area DA. The pixels PX may be arranged in various configurations/patterns such as a stripe configuration/pattern, a PenTile® configuration/pattern, a diamond configuration/pattern, a mosaic configuration/pattern, and the like to display images. Each pixel PX may include an organic light-emitting diode OLED as a display element (or a light-emitting element), and the organic light-emitting diode OLED may be connected to a pixel circuit. The pixel circuit may include transistors and at least one capacitor. The pixel PX may emit, for example, red, green, blue, or white light from the organic light-emitting diode OLED. Each pixel PX may be connected to at least one corresponding gate line among the gate lines GL and a corresponding data line among the data lines DL.

The gate lines GL may each extend in the x-axis direction (e.g., a row direction) and be connected to the pixels PX arranged in the same row. The gate lines GL may each transfer gate signal to the pixels PX in the same row. The data lines DL may each extend in the y-axis direction (e.g., a column direction) and be connected to the pixels PX arranged in the same column. The data lines DL may respectively transfer data signals to the pixels PX in the same column in synchronization with a gate signal.

In an embodiment, the peripheral area PA may be a non-display area in which the pixels PX are not arranged. In another embodiment, pixels PX may be arranged in a portion of the peripheral area PA. As an example, pixels PX may be arranged in at least one corner portion of the peripheral area PA to overlap the gate driving circuit 13. Accordingly, a dead area may be reduced and the display area DA may be extended.

The gate driving circuit 13 may be connected to the gate lines GL, generate gate signals GS according to control signals GCS from the controller 19, and sequentially supply the gate signals to the gate lines GL. The gate line GL may be connected to a gate of a transistor included in the pixel PX. A gate signal may be a gate control signal for controlling turned-on operation and turned-off operation of a transistor whose gate is connected to the gate line GL. A gate signal may be a signal including an on-voltage (or turn-on voltage) by which a transistor may be turned on, and an off-voltage (or turn-off voltage) by which a transistor may be turned off.

Although it is shown in FIG. 2 that the pixel PX is connected to one gate line GL, this is an example. The pixel PX may be connected to two or more gate lines, and the gate driving circuit 13 may supply two or more gate signals with different timings at which a turn-on voltage is applied, to the corresponding gate lines.

The data driving circuit 15 may be connected to the data lines DL and supply data signals to the data lines DL according to control signals DCS from the controller 19. The data signals supplied to the data lines DL may be supplied to the pixels PX to which gate signals are supplied. The data driving circuit 15 may convert input image data DATA into a data signal of a voltage or current form. For example, the input image data DATA may have a grayscale and input from the controller 19. FIG. 2 shows an example in which the data driving circuit 15 outputs data signals Vdata of a voltage form.

The power supply circuit 17 may generate voltages required to drive the pixels according to control signals PCS from the controller 19. The power supply circuit 17 may generate a first driving voltage ELVDD and a second driving voltage ELVSS and supply the first and second driving voltage ELVDD and ELVSS to the pixels PX. The first driving voltage ELVDD may be a high-level voltage provided to a terminal of a driving transistor connected to a first electrode (e.g., a pixel electrode or an anode) of a display element included in a pixel PX. The second driving voltage ELVSS may be a low-level voltage provided to a second electrode (e.g., an opposite electrode or a cathode) of the display element included in a pixel PX.

The controller 19 may generate control signals GCS, DCS, and PCS based on signals input from the outside, and supply them to the gate driving circuit 13, the data driving circuit 15, and the power supply circuit 17. A control signal GCS output to the gate driving circuit 13 may include clock signals and a gate start signal. The control signals DCS output to the data driving circuit 15 may include a data start signal and clock signals.

The display apparatus 10 may include a display panel, and the display panel may include a substrate. The pixels PX may be arranged in the display area DA of the substrate. A portion or all of the gate driving circuit 13 may be formed (e.g., directly formed) in the peripheral area PA of the substrate during a process of forming a transistor of the pixel circuit in the display area DA of the substrate. The data driving circuit 15, the power supply circuit 17, and the controller 19 may be formed as separate integrated circuit chips, respectively, or one integrated circuit chip, and disposed on a flexible printed circuit board (FPCB) electrically connected to a pad arranged on a side of the substrate. In another embodiment, the data driving circuit 15, the power supply circuit 17, and the controller 19 may be disposed (e.g., directly disposed) on the substrate by a chip-on-glass (COG) or chip-on-plastic (COP) method.

The display apparatus 10 may support a variable refresh rate (VRR). The refresh rate may be a frequency at which a data signal is substantially written on a driving transistor of a pixel PX, and also called a screen scan rate or a screen reproduction rate. The refresh rate may represent the number of image frames reproduced for one second. In an embodiment, the refresh rate may be an output frequency of the gate driving circuit 13 and/or the data driving circuit 15. A frequency corresponding to the refresh rate may be a driving frequency. The display apparatus 10 may adjust an output frequency of the gate driving circuit 13 and an output frequency of the data driving circuit 15 corresponding thereto according to the driving frequency. The display apparatus 10 supporting the VRR may operate by changing the driving frequency within a range between a maximum driving frequency and a minimum driving frequency. As an example, in the case where the refresh rate is about 60 Hz, a gate signal for writing a data signal from the gate driving circuit 13 may be supplied to each horizontal line (row) 60 times per second. The display apparatus 10 may display images while changing a driving frequency according to the refresh rate.

According to the driving frequency, one frame 1F may include a first scan period AS, or the first scan period AS and one or more second scan periods SS. As an example, as shown in FIG. 3A, in the display apparatus 10 that operates at a driving frequency of an about A Hz, one frame 1F may include one first scan period AS. As shown in FIG. 3B, in the display apparatus 10 that operates in a driving frequency of a B Hz less than a driving frequency of an A Hz, one frame 1F may include one first scan period AS and one or more second scan periods SS. In case that the driving frequency is low, the length of the one frame 1F may increase. In an embodiment, the A Hz in FIG. 3A may be a driving frequency of about 120 Hz, and the B Hz in FIG. 3B may be a driving frequency lower than 120 Hz, such as 10 Hz.

The first scan period AS may be defined as an address scan period in which a data signal is written in a pixel PX according to a first gate signal GW, and accordingly, the pixel PX emits light. An operation in which a data signal is written in the pixel PX from the data line DL may be referred to as a data programming operation. The second scan period SS may be defined as a self-scan period in which a first gate signal GW is not applied to a pixel PX, and a data signal is not written. During the second scan period SS, a data signal written during the first scan period AS is maintained, and a pixel may emit light according to a data signal written during the first scan period AS. The length of the second scan period SS may be equal to the length of the first scan period AS.

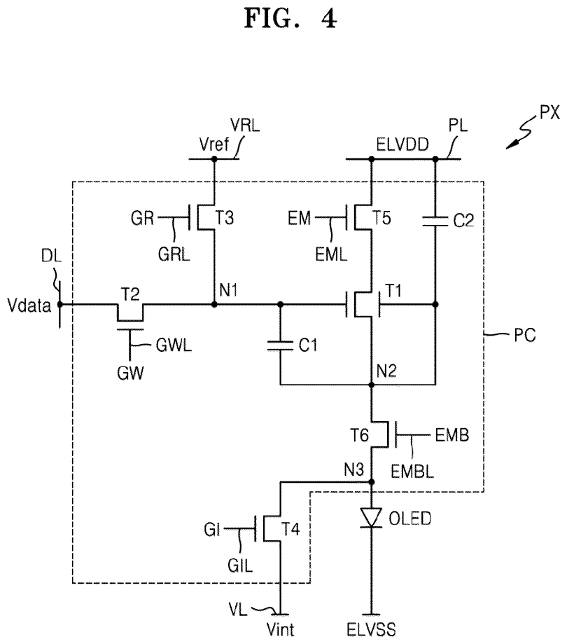

FIG. 4 is a schematic diagram of an equivalent circuit of a pixel according to an embodiment.

Referring to FIG. 4, a pixel PX may include a pixel circuit PC and an organic light-emitting diode OLED connected to the pixel circuit PC. For example, the pixel circuit PC may be connected to the gate line GL and the data line DL. In an embodiment, the gate line GL may include a first gate line GWL, a second gate line GIL, a third gate line GRL, a fourth gate line EML, and a fifth gate line EMBL.

A pixel PX may be connected to a first gate line GWL that transfers a first gate signal GW, a second gate line GIL that transfers a second gate signal GI, a third gate line GRL that transfers a third gate signal GR, a fourth gate line EML that transfers a fourth gate signal EM, a fifth gate line EMBL that transfers a fifth gate signal EMB, and a data line DL that transfers a data signal Vdata. Because light emission of the pixel PX is controlled by the fourth gate signal EM and the fifth gate signal EMB, the fourth gate signal EM and the fifth gate signal EMB may be referred to as emission control signals, and the fourth gate line EML and the fifth gate line EMBL may be also referred to as emission control lines.

For example, the pixel PX may be connected to a driving voltage line PL that transfers the first driving voltage ELVDD, a reference voltage line VRL that transfers a reference voltage Vref, and an initialization voltage line VL that transfers an initialization voltage Vint.

The first to fifth gate lines may be arranged in the pixel area 11 shown in FIG. 2, and the gate driving circuit 13 may respectively apply a first gate signal GW, a second gate signal GI, a third gate signal GR, a fourth gate signal EM, and a fifth gate signal EMB to the first gate lines GWL, the second gate lines GIL, the third gate lines GRL, the fourth gate lines EML, and the fifth gate lines EMBL. The power supply circuit 17 may generate the reference voltage Vref and the initialization voltage Vint, and supply them to the pixels PX.

A voltage level of the first driving voltage ELVDD may be greater than a voltage level of the second driving voltage ELVSS. A voltage level of the reference voltage Vref may be less than a voltage level of the first driving voltage ELVDD. A voltage level of the initialization voltage Vint may be less than a voltage level of the second driving voltage ELVSS.

In an embodiment, the transistors included in the pixel circuit PC may be N-type oxide thin-film transistors. The oxide thin-film transistor may be a low temperature polycrystalline oxide (LTPO) thin-film transistor in which an active pattern (e.g., a semiconductor) includes oxide. However, this is an example and N-type transistors are not limited thereto. As an example, an active pattern (e.g., a semiconductor) included in an N-type transistor may include an inorganic semiconductor (e.g., amorphous silicon and polycrystalline silicon) or an organic semiconductor, and the like.

The pixel circuit PC may include first to sixth transistors T1, T2, T3, T4, T5, and T6, and first and second capacitors C1 and C2. The first transistor T1 may be a driving transistor that outputs a driving current corresponding to a data signal, and the second to sixth transistors T2, T3, T4, T5, and T6 may be switching transistors that transfer signals. A first terminal (e.g., a first electrode) and a second terminal (e.g., a second electrode) of each of the first to the sixth transistors T1, T2, T3, T4, T5, and T6 may be a source or a drain according to the voltage of the first terminal and the second terminal. As an example, the first terminal may be a drain and the second terminal may be a source, or the first terminal may be a source and the second terminal may be a drain according to the voltage of the first terminal and the second terminal. A node to which a first gate of the first transistor T1 is connected may be defined as a first node N1, and a node to which a second terminal of the first transistor T1 is connected may be defined as a second node N2.

The first transistor T1 may be connected between the driving voltage line PL and the second node N2. The first transistor T1 may include a gate, a first terminal, and a second terminal connected to the second node N2. The gate of the first transistor T1 may include a first gate connected to the first node N1, and a second gate connected to the second terminal of the first transistor T1. The first gate and the second gate of the first transistor T1 may be disposed on different layers to face each other. As an example, the first gate and the second gate of the first transistor T1 may be disposed to face each other with a semiconductor layer between the first and second gates.

The first gate of the first transistor T1 may be connected to a second terminal of the second transistor T2, a first terminal of the third transistor T3, and the first capacitor C1. The second gate of the first transistor T1 may be connected to a first terminal of the sixth transistor T6, the first capacitor C1, and the second capacitor C2. The first terminal of the first transistor T1 may be connected to the driving voltage line PL through the fifth transistor T5, and the second terminal of the first transistor T1 may be connected to a pixel electrode of the organic light-emitting diode OLED through the sixth transistor T6. The first terminal of the first transistor T1 may be connected to the second terminal of the fifth transistor T5. The second terminal of the first transistor T1 may be connected to a first terminal of the sixth transistor T6, the first capacitor C1, and the second capacitor C2. The first transistor T1 may receive a data signal Vdata according to a switching operation of the second transistor T2 and control the amount of driving current flowing through the organic light-emitting diode OLED.

The second transistor T2 (e.g., a write transistor) may be connected between the data line DL and the first gate of the first transistor T1. The second transistor T2 may include a gate, a first terminal, and a second terminal. For example, the gate of the second transistor T2 may be connected to the first gate line GWL, the first terminal of the second transistor T2 may be connected to the data line DL, and the second terminal of the second transistor T2 may be connected to the first node N1. The second terminal of the second transistor T2 may be connected to the first gate of the first transistor T1, a first terminal of the third transistor T3, and the first capacitor C1. The second transistor T2 may be turned on according to a first gate signal GW transferred to the first gate line GWL to electrically connect the data line DL to the first node N1 and transfer a data signal Vdata, which is transferred through the data line DL, to the first node N1.

The third transistor T3 (e.g., a first initialization transistor) may be connected between the first gate of the first transistor T1 and the reference voltage line VRL. The third transistor T3 may include a gate, a first terminal, and a second terminal. For example, the gate of the third transistor T3 may be connected to the third gate line GRL, the first terminal of the third transistor T3 may be connected to the first node N1, and the second terminal of the third transistor T3 may be connected to the reference voltage line VRL. The first terminal of the third transistor T3 may be connected to the first gate of the first transistor T1, the second terminal of the second transistor T2, and the first capacitor C1. The third transistor T3 may be turned on according to a third gate signal GR transferred to the third gate line GRL and may transfer the reference voltage Vref, which is transferred through the reference voltage line VRL, to the first node N1.

The fourth transistor T4 (e.g., a second initialization transistor or a reset transistor) may be connected between the sixth transistor T6 and the initialization voltage line VL. The fourth transistor T4 may be connected between the organic light-emitting diode OLED and the initialization voltage line VL. The fourth transistor T4 includes a gate, a first terminal, and a second terminal. For example, the gate of the fourth transistor T4 may be connected to the second gate line GIL, the first terminal of the fourth transistor T4 may be connected to a third node N3, and the second terminal of the fourth transistor T4 may be connected to the initialization voltage line VL. The first terminal of the fourth transistor T4 may be connected to the second terminal of the sixth transistor T6 and the organic light-emitting diode OLED. The fourth transistor T4 may be turned on according to a second gate signal GI transferred to the second gate line GIL and may transfer the initialization voltage Vint, which is transferred through the initialization voltage line VL, to the third node N3.

The fifth transistor T5 (e.g., a first emission control transistor) may be connected between the driving voltage line PL and the first transistor T1. The fifth transistor T5 may include a gate, a first terminal, and a second terminal. For example, the gate of the fifth transistor T5 may be connected to the fourth gate line EML, the first terminal of the fifth transistor T5 may be connected to the driving voltage line PL, and the second terminal of the fifth transistor T5 may be connected to the first terminal of the first transistor T1. The fifth transistor T5 may be turned on or turned off according to a fourth gate signal EM transferred through the fourth gate line EML.

The sixth transistor T6 (e.g., a second emission control transistor) may be connected between the first transistor T1 and the organic light-emitting diode OLED. The sixth transistor T6 may be connected between the second node N2 and the third node N3. The sixth transistor T6 may include a gate, a first terminal, and a second terminal. For example, the gate of the sixth transistor T6 may be connected to the fifth gate line EMBL, the first terminal of the sixth transistor T6 may be connected to the second node N2, and the second terminal of the sixth transistor T6 may be connected to the third node N3. The first terminal of the sixth transistor T6 may be connected to the second terminal of the first transistor T1, the first capacitor C1, and the second capacitor C2. The second terminal of the sixth transistor T6 may be connected to the first terminal of the fourth transistor T4 and the pixel electrode of the organic light-emitting diode OLED. The sixth transistor T6 may be turned on or turned off according to a fifth gate signal EMB transferred through the fifth gate line EMBL.

The first capacitor C1 may be connected between the first gate of the first transistor T1 and the second terminal of the first transistor T1. A first electrode of the first capacitor C1 may be connected to the first node N1, and a second electrode of the first capacitor C1 may be connected to the second node N2. The first electrode of the first capacitor C1 may be connected to the first gate of the first transistor T1, the second terminal of the second transistor T2, and the first terminal of the third transistor T3. The second electrode of the first capacitor C1 may be connected to the second terminal and the second gate of the first transistor T1, the second terminal of the second capacitor C2, and the first terminal of the sixth transistor T6. The first capacitor C1 may be a storage capacitor and may store a threshold voltage of the first transistor T1 and a voltage corresponding to a data signal Vdata.

The second capacitor C2 may be connected between the driving voltage line PL and the second node N2. A first electrode of the second capacitor C2 may be connected to the driving voltage line PL. The second electrode of the second capacitor C2 may be connected to the second terminal and the second gate of the first transistor T1, the second terminal of the first capacitor C1, and the first terminal of the sixth transistor T6. A capacitance of the first capacitor C1 may be greater than a capacitance of the second capacitor C2.

The organic light-emitting diode OLED may be connected to the first transistor T1 through the sixth transistor T6. The organic light-emitting diode OLED may include the pixel electrode (e.g., the anode), the opposite electrode (e.g., the cathode). For example, the pixel electrode may be connected to the third node N3, and the opposite electrode may face the pixel electrode and may be supplied with the second driving voltage ELVSS. The opposite electrode may be a common electrode that is common over the pixels PX.

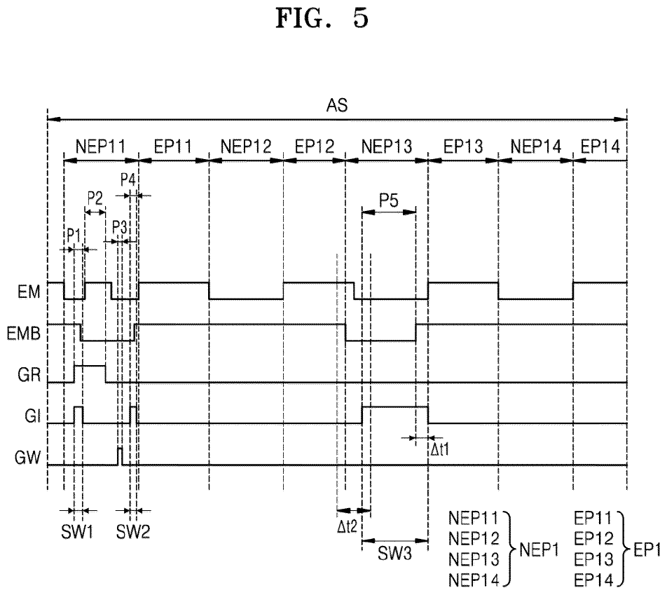

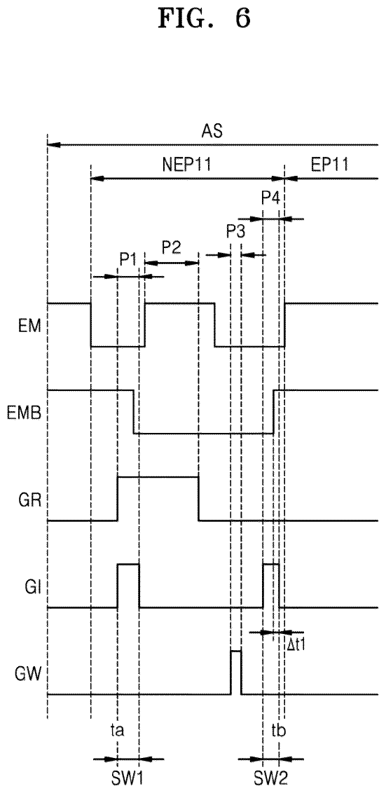

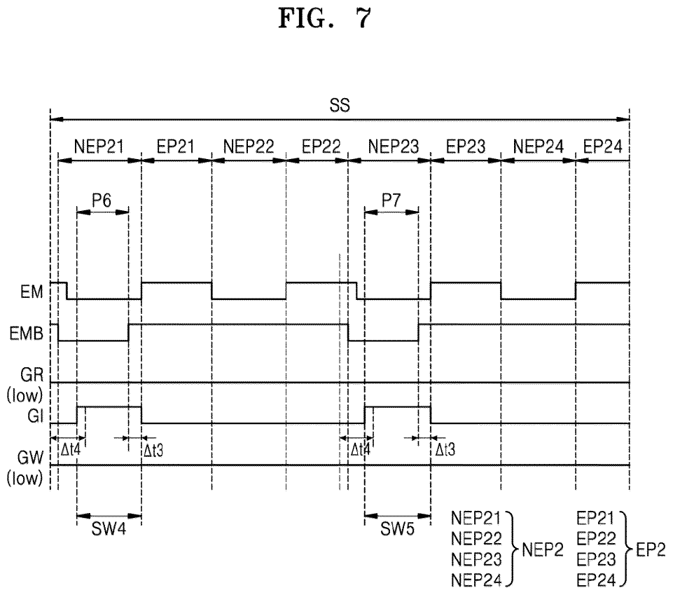

FIG. 5 is a view of signals supplied to a pixel during a first scan period AS according to an embodiment. FIG. 6 is an enlarged view of a portion of the first scan period AS of FIG. 5. FIG. 7 is a view of signals supplied to a pixel during the second scan period SS according to an embodiment.

A first gate signal GW, a second gate signal GI, a third gate signal GR, a fourth gate signal EM, and a fifth gate signal EMB may each have a high-level voltage (e.g., a first level voltage) for a partial period, and a low-level voltage (e.g., a second level voltage) for a partial period. Here, a high-level voltage may be a gate-on voltage for turning on a transistor, and a low-level voltage may be a gate-off voltage for turning off a transistor.

Referring to FIGS. 5 and 7, each of the first scan period AS and the second scan period SS may include a non-emission period in which a pixel PX does not emit light, and an emission period in which a pixel PX emits light. Each of the first scan period AS and the second scan period SS may include non-emission periods and emission periods.

A non-emission period NEP1 of the first scan period AS may include a first non-emission period NEP11, a second non-emission period NEP12, a third non-emission period NEP13, and a fourth non-emission period NEP14. An emission period EP1 of the first scan period AS may include a first emission period EP11, a second emission period EP12, a third emission period EP13, and a fourth emission period EP14.

The first emission period EP11 may be arranged between the first non-emission period NEP11 and the second non-emission period NEP12, the second emission period EP12 may be arranged between the second non-emission period NEP12 and the third non-emission period NEP13, the third emission period EP13 may be arranged between the third non-emission period NEP13 and the fourth non-emission period NEP14, and the fourth emission period EP14 may be arranged after the fourth non-emission period NEP14.

The first non-emission period NEP11 may include a first period P1, a second period P2, a third period P3, and a fourth period P4.

The first period P1 may be a first initialization period (e.g., a reset period) that initializes a voltage of the first node N1 to which the gate (e.g., a first gate) of the first transistor T1 is connected, and a voltage of the third node N3 to which the pixel electrode of the organic light-emitting diode OLED is connected. During the first period P1, the gate driving circuit 13 may output (or supply) a second gate signal GI of a gate-on voltage to the second gate line GIL, output a fifth gate signal EMB of a gate-on voltage to the fifth gate line EMBL, and output a third gate signal GR of a gate-on voltage to the third gate line GRL. The gate driving circuit 13 may output a first gate signal GW and a fourth gate signal EM of a gate-off voltage.

The sixth transistor T6 may be turned on according to a fifth gate signal EMB, the fourth transistor T4 may be turned on according to a second gate signal GI, and the third transistor T3 may be turned on according to a third gate signal GR. Voltages of the second node N2 and the third node N3 may be initialized to the initialization voltage Vint by the sixth transistor T6 and the fourth transistor T4 that are turned on. A voltage of the first node N1, e.g., the first gate of the first transistor T1 may be initialized to the reference voltage Vref by the third transistor T3 that is turned on.

The second period P2 may be a compensation period of compensating for a threshold voltage of the first transistor T1. During the second period P2, the gate driving circuit 13 may output a third gate signal GR of a gate-on voltage to the third gate line GRL, and output a fourth gate signal EM of a gate-on voltage to the fourth gate line EML. The gate driving circuit 13 may output a first gate signal GW, a second gate signal GI, and a fifth gate signal EMB of a gate-off voltage.

The third transistor T3 may be turned on by a third gate signal GR, and the fifth transistor T5 may be turned on by a fourth gate signal EM. Accordingly, the reference voltage Vref may be supplied to the first node N1, and the first driving voltage ELVDD may be supplied to the first terminal of the first transistor T1, and thus, the first transistor T1 may be turned on. In case that the voltage of the second terminal of the first transistor T1 reaches (or becomes) a difference Vref-Vth between the reference voltage Vref and the threshold voltage Vth of the first transistor T1, the first transistor T1 may be turned off. For example, because a voltage corresponding to the threshold voltage Vth of the first transistor T1 may be stored in the first capacitor C1, the threshold voltage Vth of the first transistor T1 may be compensated for.

The third period P3 may be a write-period in which data signals are supplied to a pixel. During the third period P3, the gate driving circuit 13 may output a first gate signal GW of a gate-on voltage to the first gate line GWL. The gate driving circuit 13 may output a second gate signal GI, a third gate signal GR, a fourth gate signal EM, and a fifth gate signal EMB of a gate-off voltage.

The second transistor T2 may be turned on according to a first gate signal GW, and the second transistor T2, which is turned on, may transfer a data signal Vdata from the data line DL to the first node N1, e.g., the first gate of the first transistor T1. Accordingly, the voltage of the first node N1 may be changed from the reference voltage Vref to a voltage corresponding to the data signal Vdata. In this case, the voltage of the second node N2 may also change in response to the amount of voltage change of the first node N1. The voltage of the second node N2 may become a voltage (Vref-Vth+α×(Vdata-Vref)) that changes according to a capacitance ratio (a=C1/(C1+C2)) of the first capacitor C1 and the second capacitor C2. Accordingly, the first capacitor C1 may be charged with a voltage corresponding to a data signal Vdata of the first transistor T1.

The fourth period P4 may be a second initialization period before the emission period EP1 after data is written, in which a voltage of the second node N2 connected to the second terminal of the first transistor T1, and a voltage of the third node N3 connected to the pixel electrode of the organic light-emitting diode OLED are initialized. During the fourth period P4, the gate driving circuit 13 may output a second gate signal GI of a gate-on voltage to the second gate line GIL, and output a fifth gate signal EMB of a gate-on voltage to the fifth gate line EMBL. The gate driving circuit 13 may output a first gate signal GW, a third gate signal GR, and a fourth gate signal EM of a gate-off voltage.

During the fourth period P4, before a fourth gate signal EM transitions from a gate-off voltage to a gate-on voltage, a fourth gate signal EM of a gate-off voltage may overlap at least a portion of a second gate signal GI of a gate-on voltage and a fifth gate signal EMB of a gate-on voltage. The fourth transistor T4 may be turned on according to a second gate signal GI, and the initialization voltage Vint may be transferred to the pixel electrode of the organic light-emitting diode OLED by the fourth transistor T4 that is turned on. Subsequently, the sixth transistor T6 may be turned on according to a fifth gate signal EMB, and the second node N2 and the third node N3 may share charge due to the sixth transistor T6 and the fourth transistor T4 that are turned on.

During the second non-emission period NEP12, in case that a fourth gate signal EM of a gate-off voltage is supplied to the fourth gate line EML, and a fifth gate signal EMB of a gate-on voltage may be supplied to the fifth gate line EMBL. The fifth transistor T5 may be turned off according to a fourth gate signal EM, and the organic light-emitting diode OLED may be configured not to emit light. Because the sixth transistor T6 maintains a turned-on state in the emission period EP due to a fifth gate signal EMB during the third non-emission period NEP13, a voltage of the pixel electrode of the organic light-emitting diode OLED in the emission period EP may be maintained during the third non-emission period NEP13.

The third non-emission period NEP13 may include a fifth period P5.

The fifth period P5 may be a third initialization period that initializes a voltage of the third node N3 to which the pixel electrode of the organic light-emitting diode OLED is connected. During the fifth period P5, the gate driving circuit 12 may output a second gate signal GI of a gate-on voltage to the second gate line GIL. The gate driving circuit 13 may output a first gate signal GW, a third gate signal GR, a fourth gate signal EM, and a fifth gate signal EMB of a gate-off voltage.

The fourth transistor T4 may be turned on according to a second gate signal GI. A voltage of the third node N3, e.g., the pixel electrode of the organic light-emitting diode OLED may be initialized to the initialization voltage Vint by the fourth transistor T4.

A period SW3 (referred to as a ‘gate-on-voltage period’, hereinafter) (e.g., a signal width) during which the second gate signal GI is maintained at a gate-on voltage in the third non-emission period NEP13 may be greater than a gate-on-voltage period SW1 and SW2 of a second gate signal GI in the first non-emission period NEP11. In an embodiment, the gate-on-voltage period SW3 of a second gate signal GI in the third non-emission period NEP13 may be approximately a period from a time point ta at which the first period P1 starts to a time point tb at which the fourth period P4 ends, and is within a period (referred to as a ‘gate-off-voltage period’, hereinafter) in which a fourth gate signal EM is maintained at a gate-off voltage in the third non-emission period NEP13.

The emission period EP1 may be a period during which the organic light-emitting diode OLED emits light. During the emission period EP1, the gate driving circuit 13 may output a fourth gate signal EM of a gate-on voltage to the fourth gate line EML, and output a fifth gate signal EMB of a gate-on voltage to the fifth gate line EMBL. The gate driving circuit 13 may output a first gate signal GW, a second gate signal GI, and a third gate signal GR of a gate-off voltage.

During the emission period EP1, the fifth transistor T5 may be turned on according to a fourth gate signal EM, and the first driving voltage ELVDD may be supplied to the first terminal of the first transistor T1 by the fifth transistor T5 that is turned on. The first transistor T1 may output a driving current (Id∝(Vgs-Vth)²), and the driving current may flow through the organic light-emitting diode OLED via the sixth transistor T6 that is turned on according to a fifth gate signal EMB, and the organic light-emitting diode OLED may emit light at a brightness corresponding to the driving current. For example, the driving current may correspond to a voltage corresponding to a data signal Vdata stored in the first capacitor C1, e.g., a voltage (Vgs-Vth) obtained by subtracting the threshold voltage Vth of the first transistor T1 from a gate-source voltage Vgs of the first transistor T1.

Before the first emission period EP11 starts and the third emission period EP13 starts, in case of outputting a fourth gate signal EM of a gate-off voltage, the gate driving circuit 13 may output a second gate signal GI of a gate-on voltage and a fifth gate signal EMB of a gate-on voltage. In this case, a second gate signal GI of a gate-on voltage may be output first, and subsequently, a fifth gate signal EMB of a gate-on voltage may be output. In an embodiment, a second gate signal GI of a gate-on voltage and a fifth gate signal EMB of a gate-on voltage may at least partially overlap each other. In another embodiment, a second gate signal GI of a gate-on voltage and a fifth gate signal EMB of a gate-on voltage may not overlap each other.

During a period At1 in which a second gate signal GI of a gate-on voltage and a fifth gate signal EMB of a gate-on voltage overlap each other, the fourth transistor T4 and the sixth transistor T6 may be turned on according to the second gate signal GI and the fifth gate signal EMB, and the second node N2 and the third node N3 may be electrically connected to each other by the turned-on fourth transistor T4 and sixth transistor T6 to share charge. Because the fourth transistor T4 and the sixth transistor T6 are turned on first before the fifth transistor T5 is turned on, a voltage of the third node N3, e.g., a voltage of the pixel electrode of the organic light-emitting diode OLED may be stabilized.

During the third non-emission period NEP13, before transitioning a second gate signal GI from a gate-off voltage to a gate-on voltage to output the gate-on voltage, the gate driving circuit 13 may transition a fifth gate signal EMB from a gate-on voltage to a gate-off voltage to output the gate-off voltage. As an example, during a boundary period At2 between the second emission period EP12 and the third non-emission period NEP13, before transitioning a fourth gate signal EM from a gate-on voltage to a gate-off voltage to output the gate-off voltage, the gate driving circuit 13 may transition a fifth gate signal EMB from a gate-on voltage to a gate-off voltage to output the gate-off voltage. In this case, the second gate signal GI may be a gate-off voltage. Accordingly, the sixth transistor T6 may be turned off, and then the fifth transistor T5 may be turned off. After the sixth transistor T6 and the fifth transistor T5 are turned off, the gate driving circuit 13 may transition a second gate signal GI from a gate-off voltage to a gate-on voltage to output the gate-off voltage, and the fourth transistor T4 may be turned on. Accordingly, the voltage of the third node N3, e.g., the voltage of the pixel electrode of the organic light-emitting diode OLED may be initialized. During the third non-emission period NEP13, the gate-on-voltage period SW3 of a second gate signal GI may be greater than the first period P1 and the fourth period P4. Accordingly, in case that the fifth transistor T5 is turned off, the voltage drop of the first driving voltage ELVDD may be reduced, and in case that the fifth transistor T5 and the sixth transistor T6 are turned off, a brightness change of the organic light-emitting diode OLED due to a leakage current may be reduced.

A non-emission period NEP2 of the second scan period SS may include a first non-emission period NEP21, a second non-emission period NEP22, a third non-emission period NEP23, and a fourth non-emission period NEP24. An emission period EP2 of the second scan period SS may include a first emission period EP21, a second emission period EP22, a third emission period EP23, and a fourth emission period EP24.

The first emission period EP21 may be arranged between the first non-emission period NEP21 and the second non-emission period NEP22, the second emission period EP22 may be arranged between the second non-emission period NEP22 and the third non-emission period NEP23, the third emission period EP23 may be arranged between the third non-emission period NEP23 and the fourth non-emission period NEP24, and the fourth emission period EP24 may be arranged after the fourth non-emission period NEP24.

The first non-emission period NEP21 may not include a compensation period and a write period included in the first non-emission period NEP11 of the first scan period AS, and may include a sixth period P6 corresponding to the fourth period P4, which is an initialization period.

The sixth period P6 may be a fourth initialization period that initializes a voltage of the third node N3 to which the pixel electrode of the organic light-emitting diode OLED is connected. During the sixth period P6, the gate driving circuit 12 may output a second gate signal GI of a gate-on voltage to the second gate line GIL. The gate driving circuit 13 may output a first gate signal GW, a third gate signal GR, a fourth gate signal EM, and a fifth gate signal EMB of a gate-off voltage. The fourth transistor T4 may be turned on according to a second gate signal GI. A voltage of the third node N3, e.g., the pixel electrode of the organic light-emitting diode OLED may be initialized to the initialization voltage Vint by the fourth transistor T4.

Because an output of the gate driving circuit 13 and an operation of a pixel during the second non-emission period NEP22 and the fourth non-emission period NEP24 are respectively the same as an output of the gate driving circuit 13 and an operation of a pixel during the second non-emission period NEP12 and the fourth non-emission period NEP14 of the first scan period AS, redundant descriptions thereof are omitted for descriptive convenience.

The third non-emission period NEP23 may include a seventh period P7.

The seventh period P7 may be a fifth initialization period that initializes a voltage of the third node N3 to which the pixel electrode of the organic light-emitting diode OLED is connected. During the seventh period P7, the gate driving circuit 13 may output a second gate signal GI of a gate-on voltage to the second gate line GIL. The gate driving circuit 13 may output a first gate signal GW, a third gate signal GR, a fourth gate signal EM, and a fifth gate signal EMB of a gate-off voltage. The fourth transistor T4 may be turned on according to a second gate signal GI. A voltage of the third node N3, e.g., the pixel electrode of the organic light-emitting diode OLED may be initialized to the initialization voltage Vint by the fourth transistor T4.

A gate-on-voltage period SW4 of a second gate signal GI during the first non-emission period NEP21 may be the same as a gate-on-voltage period SW5 of a second gate signal GI during the third non-emission period NEP23. A gate-on-voltage period SW4 of a second gate signal GI during the first non-emission period NEP21 and a gate-on-voltage period SW5 of a second gate signal GI during the third non-emission period NEP23 may be the same as a gate-on-voltage period SW3 of a second gate signal GI during the third non-emission period NEP13 of the first scan period AS.

The emission period EP2 may be a period during which the organic light-emitting diode OLED emits light. A driving current output by the first transistor T1 during the emission period EP2 may be a current corresponding to a data signal Vdata supplied to a pixel and stored and maintained in the first capacitor C1 during a write period of the first scan period AS. Because an output of the gate driving circuit 13 and an operation of a pixel during the emission period EP2 are the same as an output of the gate driving circuit 13 and an operation of a pixel during the emission period EP1 of the first scan period AS, redundant descriptions thereof are omitted for descriptive convenience.

Before the first emission period EP21 starts and the third emission period EP23 starts, during a period At3 in which a second gate signal GI of a gate-on-voltage and a fifth gate signal EMB of a gate-on-voltage overlap each other, the fourth transistor T4 and the sixth transistor T6 may be turned on according to a second gate signal GI and a fifth gate signal EMB, and the second node N2 and the third node N3 may be electrically connected to each other by the turned-on fourth transistor T4 and sixth transistor T6 to share charge. Because the fourth transistor T4 and the sixth transistor T6 are turned on first before the fifth transistor T5 is turned on, a voltage of the third node N3, e.g., a voltage of the pixel electrode of the organic light-emitting diode OLED may be stabilized.

During the first non-emission period NEP21 and the third non-emission period NEP23, the gate driving circuit 13 may transition a fifth gate signal EMB from a gate-on voltage to a gate-off voltage to output the gate-off voltage, and then transition a second gate signal GI from a gate-off voltage to a gate-on voltage to output the gate-on voltage. As an example, during a boundary period At4 between the fourth emission period EP24 and the first non-emission period NEP21 and a boundary period At4 between the second emission period EP22 and the third non-emission period NEP23, before a fourth gate signal EM transitions from a gate-on voltage to a gate-off voltage, a fifth gate signal EMB may transition from a gate-on voltage to a gate-off voltage first. In this case, the second gate signal GI may be a gate-off voltage. Accordingly, the sixth transistor T6 may be turned off, and then the fifth transistor T5 may be turned off. After both the sixth transistor T6 and the fifth transistor T5 are turned off, a second gate signal GI may transition from a gate-off voltage to a gate-on voltage, and the fourth transistor T4 may be turned on. Accordingly, the voltage of the third node N3, e.g., the voltage of the pixel electrode of the organic light-emitting diode OLED may be initialized. Then, during the third non-emission period NEP23, the gate-on-voltage period SW5 of a second gate signal GI may be maintained longer than the first period P1 and the fourth period P4. Accordingly, in case that the fifth transistor T5 is turned off, the voltage drop of the first driving voltage ELVDD may be reduced, and in case that the fifth transistor T5 and the sixth transistor T6 are turned off, a brightness change of the organic light-emitting diode OLED due to a leakage current may be reduced.

In an embodiment, as shown in FIG. 3A, in the case where the display apparatus 10 is driven at about A Hz (e.g., about 120 Hz), one frame may include one first scan period AS shown in FIG. 5 and one frame may include four non-emission periods and four emission periods.

Among the four non-emission periods, a first non-emission period (e.g., a first non-emission period NEP11) may include the first period P1, the second period P2, the third period P3, and the fourth period P4. Among the four non-emission periods, during even-numbered non-emission periods (e.g., the second non-emission period NEP12 and the fourth non-emission period NEP14), the fifth transistor T5 may be turned off according to a fourth gate signal EM of a gate-off voltage, and the sixth transistor T6 may be turned on according to a fifth gate signal EMB of a gate-on voltage. Among the four non-emission periods, during odd-numbered non-emission periods (e.g., the first non-emission period NEP11 and the third non-emission period NEP13), the fourth transistor T4 may be turned on according to a second gate signal GI of a gate-on voltage. A period during which the fourth transistor T4 is turned on in the third non-emission period NEP13 may be longer than a period (e.g., a gate-on-voltage period of a second gate signal GI) during which the fourth transistor T4 is turned on in the first non-emission period NEP11. The fifth transistor T5 may be turned off and the sixth transistor T6 may be turned on in a portion of a period during which the fourth transistor T4 is turned on in each of the odd-numbered non-emission periods.

Among the four non-emission periods, during odd-numbered non-emission periods (e.g., the third non-emission period NEP13) other than the first non-emission period NEP11, after a fifth gate signal EMB transitions from a gate-on voltage to a gate-off voltage and the fifth transistor T5 switches from a turned-on state to a turned-off state, a second gate signal GI transitions from a gate-off voltage to a gate-on voltage, and thus, the fourth transistor T4 may switch from a turned-off state to a turned-on state. More specifically, among the four emission periods, during a boundary period (e.g., a boundary period At2 between the second emission period EP12 and the third non-emission period NEP13) between an even-numbered emission period and a non-emission period subsequent to the even-numbered emission period, before a fourth gate signal EM transitions from a gate-on voltage to a gate-off voltage and the fifth transistor T5 switches from a turned-on state to a turned-off state, a fifth gate signal EMB transitions from a gate-on voltage to a gate-off voltage, and thus, the sixth transistor T6 may switch from a turned-on state to a turned-off state. After the fifth transistor T5 switches from a turned-on state to a turned-off state, a second gate signal GI transitions from a gate-off voltage to a gate-on voltage, and thus, the fourth transistor T4 may switch from a turned-off state to a turned-on state.

In an embodiment, as shown in FIG. 3B, in the case where the display apparatus 10 is driven at about B Hz, one frame may include one first scan period AS shown in FIG. 5 and one or more second scan periods SS shown in FIG. 7 and subsequent to the first scan period AS. In the case where one frame includes two or more second scan periods SS, the non-emission period NEP2 and the emission period EP2 of the second scan period SS in FIG. 7 may be alternately repeated. Accordingly, the first non-emission period NEP21 of the second scan period SS may be subsequent to the fourth emission period EP24 of the first scan period AS.

One frame may include eight or more non-emission periods (e.g., the first non-emission period NEP11, the second non-emission period NEP12, the third non-emission period NEP13, and the fourth non-emission period NEP14 of the first scan period AS, and the first non-emission period NEP21, the second non-emission period NEP22, the third non-emission period NEP23, and the fourth non-emission period NEP24 of the second scan period SS) and eight or more emission periods (e.g., the first emission period EP11, the second emission period EP12, the third emission period EP13, and the fourth emission period EP14 of the first scan period AS, and the first emission period EP21, the second emission period EP22, the third emission period EP23, and the fourth emission period EP24 of the second scan period SS).

Among the eight or more non-emission periods, a first non-emission period (e.g., the first non-emission period NEP11 of the first scan period AS) may include the first period P1, the second period P2, the third period P3, and the fourth period P4. Among eight or more non-emission periods, during even-numbered non-emission periods (e.g., the second non-emission period NEP12 and the fourth non-emission period NEP14 of the first scan period AS, and the second non-emission period NEP22 and the fourth non-emission period NEP24 of the second scan period SS), the fifth transistor T5 may be turned off according to a fourth gate signal EM of a gate-off voltage, and the sixth transistor T6 may be turned on according to a fifth gate signal EMB of a gate-on voltage. Among eight or more non-emission periods, during odd-numbered non-emission periods (e.g., the first non-emission period NEP11 and the third non-emission period NEP13 of the first scan period AS, and the first non-emission period NEP21 and the third non-emission period NEP23 of the second scan period SS), the fourth transistor T4 may be turned on according to a second gate signal GI of a gate-on voltage. A period during which the fourth transistor T4 is turned on in remaining odd-numbered non-emission periods (e.g., the third non-emission period NEP13 of the first scan period AS, and the first non-emission period NEP21 and the third non-emission period NEP23 of the second scan period SS) may be longer than a period during which the fourth transistor T4 is turned on (e.g., a gate-on-voltage period of a second gate signal GI) in the first non-emission period NEP11. The fifth transistor T5 may be turned off and the sixth transistor T6 may be turned on in a portion of a period during which the fourth transistor T4 is turned on in each of the odd-numbered non-emission periods.

Among eight or more non-emission periods, during odd-numbered non-emission periods (e.g., the third non-emission period NEP13 of the first scan period AS, and the first non-emission period NEP21 and the third non-emission period NEP23 of the second scan period SS) other than the first non-emission period NEP11, after a fifth gate signal EMB transitions from a gate-on voltage to a gate-off voltage and the fifth transistor T5 switches from a turned-on state to a turned-off state, a second gate signal GI transitions from a gate-off voltage to a gate-on voltage, and thus, the fourth transistor T4 may switch from a turned-off state to a turned-on state. More specifically, among eight or more emission periods, during boundary periods between even-numbered emission periods and non-emission periods subsequent to the even-number emission periods (e.g., a boundary period At2 between the second emission period EP12 and the third non-emission period NEP13 of the first scan period AS, a boundary period between the fourth emission period EP14 of the first scan period AS and the first non-emission period NEP21 of the second scan period SS, a boundary period At4 between the fourth emission period EP24 and the first non-emission period NEP21 of the second scan period SS, and a boundary period At4 between the second emission period EP22 and the third non-emission period NEP23 of the second scan period SS), before a fourth gate signal EM transitions from a gate-on voltage to a gate-off voltage and the fifth transistor T5 switches from a turned-on state to a turned-off state, a fifth gate signal EMB transitions from a gate-on voltage to a gate-off voltage, and thus, the sixth transistor T6 may switch from a turned-on state to a turned-off state. After the fifth transistor T5 switches from a turned-on state to a turned-off state, a second gate signal GI transitions from a gate-off voltage to a gate-on voltage, and thus, the fourth transistor T4 may switch from a turned-off state to a turned-on state.

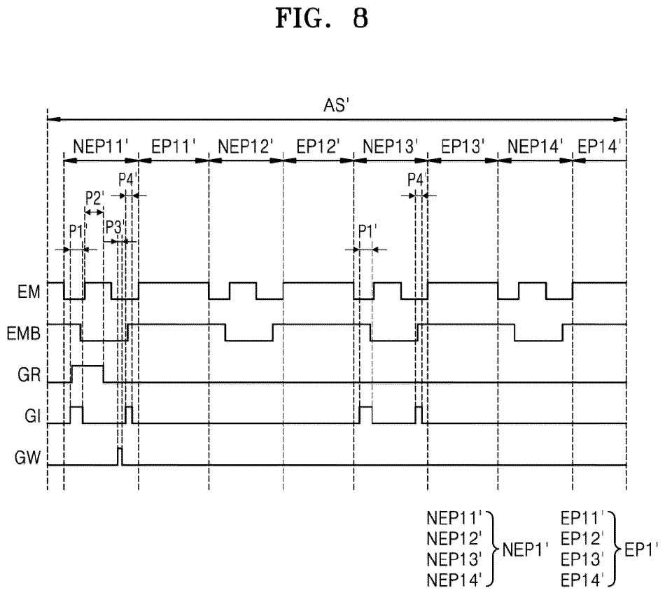

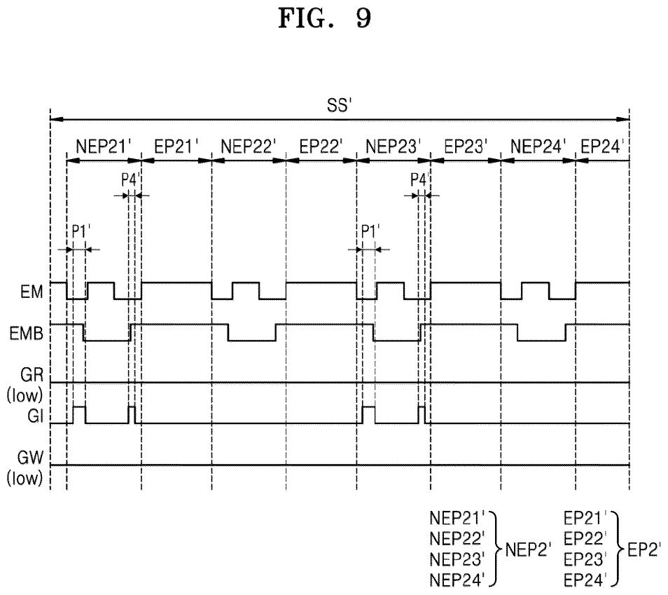

FIGS. 8 and 9 are views of signals supplied to a pixel during a first scan period and a second scan period according to a comparative example.

Referring to FIG. 8, a non-emission period NEP1′ of a first scan period AS' according to a comparative example may include a first non-emission period NEP11′, a second non-emission period NEP12′, a third non-emission period NEP13′, and a fourth non-emission period NEP14′. An emission period EP1′ of the first scan period AS' may include a first emission period EP11′, a second emission period EP12′, a third emission period EP13′, and a fourth emission period EP14′.

Referring to FIG. 9, a non-emission period NEP2′ of a second scan period SS' according to a comparative example may include a first non-emission period NEP21′, a second non-emission period NEP22′, a third non-emission period NEP23′, and a fourth non-emission period NEP24′. An emission period EP2′ of the second scan period SS' may include a first emission period EP21′, a second emission period EP22′, a third emission period EP23′, and a fourth emission period EP24′.

The non-emission period NEP1′ of the first scan period AS' according to a comparative example may include a first period P1′, a second period P2′, a third period P3′, and a fourth period P4′. The first period P1′, the second period P2′, the third period P3′, and the fourth period P4′ of the first scan period AS' may respectively correspond to the first period P1, the second period P2, the third period P3, and the fourth period P4 according to an embodiment.

Each of the first non-emission period NEP11′ and the third non-emission period NEP13′ of the first scan period AS′, and the first non-emission period NEP21′ and the third non-emission period NEP23′ of the second scan period SS' according to a comparative example may include the first period P1′ and the fourth period P4′, which are initialization periods.

During each of the first non-emission period NEP11′, a second non-emission period NEP12′, a third non-emission period NEP13′, and a fourth non-emission period NEP14′ of the first scan period AS′, and the first non-emission period NEP21′, the second non-emission period NEP22′, the third non-emission period NEP23′, and the fourth non-emission period NEP24′ of the second scan period SS' according to a comparative example, a fourth gate signal EM may be supplied in the order of a gate-off voltage, a gate-on voltage, and a gate-off voltage, and a fifth gate signal EMB may be supplied in the order of a gate-on voltage, a gate-off voltage, and a gate-on voltage.

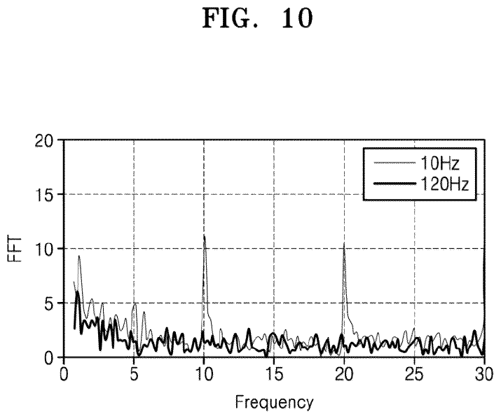

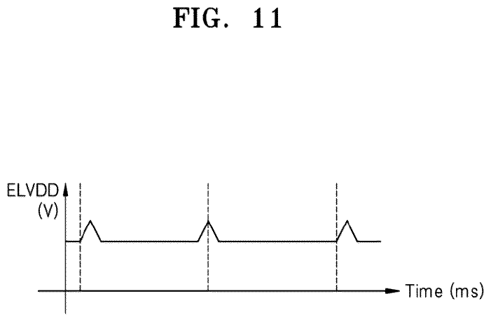

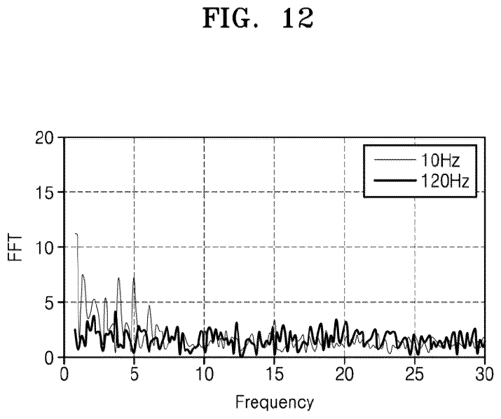

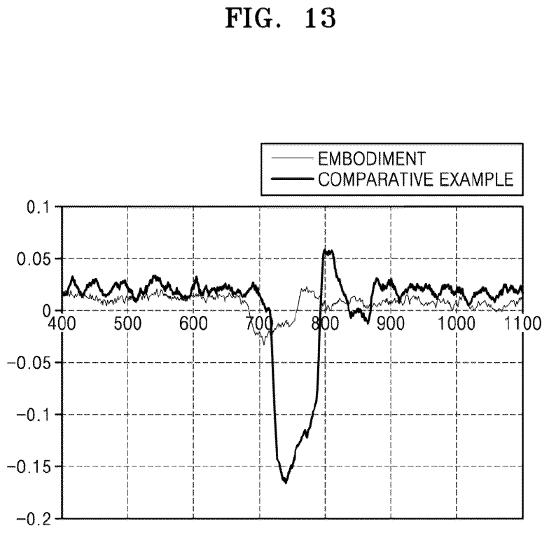

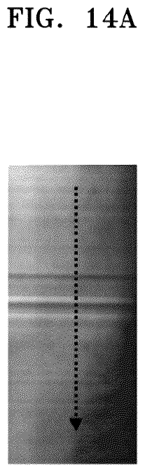

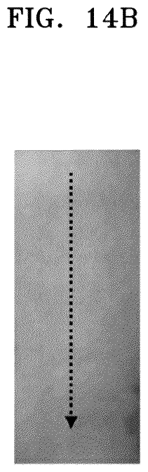

FIG. 10 is a view showing a flicker characteristic difference for each frequency in case that a pixel shown in FIG. 4 operates according to a comparative example. FIG. 11 is a view showing a driving voltage change in case that a pixel shown in FIG. 4 operates according to a comparative example. FIG. 12 is a view showing a flicker characteristic difference for each frequency in case that a pixel shown in FIG. 4 operates according to an embodiment. FIG. 13 is a view showing a brightness change in a portion of an image in case that a pixel shown in FIG. 4 operates according to an embodiment and a comparative example. A horizontal axis of FIG. 13 represents the position of a pixel line (e.g., a pixel row), and a vertical axis represents brightness. FIG. 14A is a view showing a mura effect (a visual unevenness or irregularity) occurring in a portion of an image according to a comparative example. FIG. 14B is a view of an image according to an embodiment showing a state in which the mura effect is prevented. An arrow in FIGS. 14A and 14B represents a direction of a pixel line corresponding to the horizontal axis of FIG. 13.

As shown in FIG. 10, in the case where a pixel PX operates according to the first scan period AS' and the second scan period SS' shown in FIGS. 8 and 9, upon frequency analysis of image signals using fast Fourier transform (FFT), there is a flicker characteristic difference between an operation at a high frequency (e.g., about 120 Hz) and an operation at a low frequency (e.g., about 10 Hz). A flicker (or power-line flicker) may be understood as a visible change in brightness of a pixel due to rapid fluctuations in the voltage of the power supply.

For example, as shown in FIG. 11, during each of the first scan period AS and the second scan period, because a second gate signal GI is supplied to a pixel PX at a period of 2 cycles, a change of the first driving voltage ELVDD measured for the entire panel occurs twice. Accordingly, as shown in FIG. 13, in a comparative example, because each pixel PX is influenced by rising and falling of the first driving voltage ELVDD according to an operation state thereof and brightness deterioration occurs in a portion of an image, the mura effect of a horizontal line shape may occur as shown in FIG. 14A.

In contrast, as shown in FIG. 12, in the case where a pixel operates according to the first scan period AS and the second scan period SS shown in FIGS. 5 and 7, upon frequency analysis of image signals using fast Fourier transform (FFT), a flicker characteristic difference is similar between an operation at a high frequency (e.g., about 120 Hz) and an operation at a low frequency (e.g., about 10 Hz). For example, as shown in FIG. 13, in case that the pixel PX operates according to an embodiment, because brightness deterioration in a portion of an image is reduced compared to a comparative example, the mura effect of a horizontal line shape may be reduced as shown in FIG. 14B.

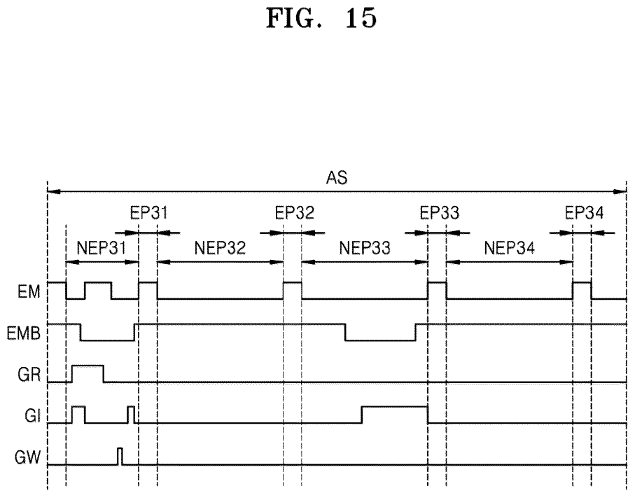

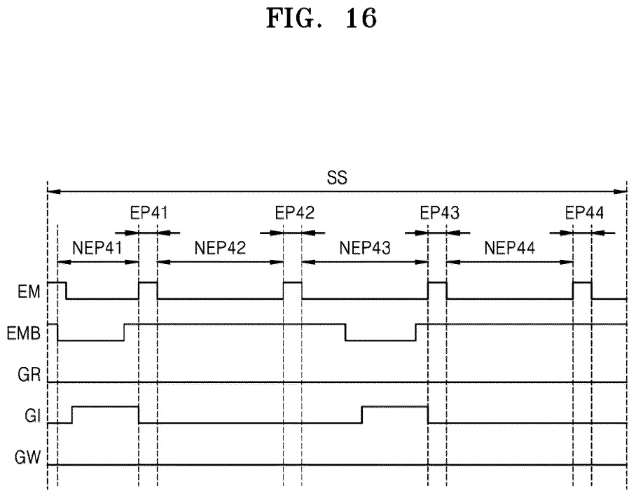

FIG. 15 is a view of signals supplied to a pixel during a first scan period according to an embodiment. FIG. 16 is a view of signals supplied to a pixel during a second scan period SS according to an embodiment. Hereinafter, the description will focus on the differences from the first scan period AS and the second scan period SS shown in FIGS. 5 to 7.

The brightness of the display apparatus may be adjusted according to an emission ratio (or, an active-matrix organic light-emitting diode (AMOLED) off ratio (AOR)). As an example, in case that the AMOLED off ratio (AOR) increases, the brightness of the display apparatus may be reduced. The controller 19 (see FIG. 2) may supply a control signal GCS to the gate driving circuit 13. For example, the control signal GCS may correspond to a dimming mode of the display apparatus. The dimming mode may be a mode that adjusts the brightness of the display apparatus. The gate driving circuit 13 may change a gate-on-voltage period and a gate-off-voltage period of a fourth gate signal EM according to the AMOLED off ratio (AOR) of the dimming mode in response to a control signal GCS. As the AMOLED off ratio (AOR) increases, a gate-off-voltage period of a fourth gate signal EM may increase, and a gate-on-voltage period may decrease. Accordingly, an emission period may decrease, and a non-emission period may increase. As an emission period decreases, the brightness of the organic light-emitting diode OLED may decrease.

As shown in FIGS. 15 and 16, a first emission period EP31, a second emission period EP32, a third emission period EP33, and a fourth emission period EP34 of the first scan period AS, and a first emission period EP41, a second emission period EP42, a third emission period EP43, and a fourth emission period EP44 of the second scan period SS may be adjusted according to the AMOLED off ratio (AOR). For example, a first non-emission period NEP31, a second non-emission period NEP32, a third non-emission period NEP33, and a fourth non-emission period NEP34 of the first scan period AS, and a first non-emission period NEP41, a second non-emission period NEP42, a third non-emission period NEP43, and a fourth non-emission period NEP44 of the second scan period SS may be adjusted according to the AMOLED off ratio (AOR).

Even in the case where an emission period decreases due to an increase of the AMOLED off ratio (AOR), a supply timing relationship of a gate-on-voltage and a gate-off-voltage of gate signals during the first scan period AS and the second scan period SS is as shown in FIGS. 5 to 7.

During the second non-emission period NEP32 and the fourth non-emission period NEP34 of the first scan period AS, and the second non-emission period NEP42 and the fourth non-emission period NEP44 of the second scan period SS, in case that a fourth gate signal EM of a gate-off voltage is supplied to the fourth gate line EML, a fifth gate signal EMB of a gate-on voltage may be supplied to the fifth gate line EMBL.

A gate-on-voltage period of a second gate signal GI in the third non-emission period NEP33 of the first scan period AS, and a gate-on-voltage period of a second gate signal GI in the third non-emission period NEP43 of the second scan period SS, may be approximately a period from a time point at which a first period of the first scan period AS starts, to a time point at which a fourth period ends, and is within a gate-off-voltage period of a fourth gate signal EM.

For example, before the first emission periods EP31 and EP41 start and the third emission periods EP33 and EP43 start, in case that a fourth gate signal EM of a gate-off voltage is supplied, a second gate signal GI of a gate-on voltage and a fifth gate signal EMB of a gate-on voltage may be supplied.

During boundary periods between the second emission periods EP32 and EP42 and the third non-emission periods NEP33 and NEP43, before a fourth gate signal EM transitions from a gate-on-voltage to a gate-off voltage, a fifth gate signal EMB transitions from a gate-on-voltage to a gate-off voltage first, and after both the sixth transistor T6 and the fifth transistor T5 are turned off, a second gate signal GI may transition from a gate-off voltage to a gate-on voltage.

An embodiment may improve an image quality by adjusting driving timing of a pixel including N-type oxide thin-film transistors. A pixel may include a transistor (e.g., the fourth transistor T4 in FIG. 4) that initializes a voltage of the pixel electrode of the organic light-emitting diode OLED, a transistor (e.g., the fifth transistor T5 in FIG. 4) between a driving voltage line that supplies the first driving voltage ELVDD and a driving transistor, and a transistor (e.g., the sixth transistor T6 in FIG. 4) between the driving transistor and the organic light-emitting diode OLED, and the fifth transistor T5 and the sixth transistor T6 may be independently turned on and turned off according to different gate signals.

In an embodiment, before a gate signal supplied to the fifth transistor T5 transitions from a gate-off voltage to a gate-on voltage, gate signals of a gate-on voltage may be supplied to the fourth transistor T4 and the sixth transistor T6. Accordingly, before the fifth transistor T5 is turned on, the voltage of the pixel electrode may be stabilized.

In an embodiment, in case that a gate signal of a gate-off voltage is supplied to the fifth transistor T5, a gate signal of a gate-on voltage may be supplied to a gate of the sixth transistor T6. Accordingly, in case that the fifth transistor T5 is turned off, the voltage of the pixel electrode may be maintained.

In an embodiment, before a gate signal supplied to the fifth transistor T5 transitions from a gate-on voltage to a gate-off voltage, a gate signal supplied to the sixth transistor T6 transitions from a gate-on voltage to a gate-off voltage first, and after both the fifth transistor T5 and the sixth transistor T6 are turned off, a gate signal supplied to the fourth transistor T4 may transition from a gate-off voltage to a gate-on voltage. Then, in case that the fifth transistor T5 is turned off, the fourth transistor T4 may be turned off. Accordingly, in case that the fifth transistor T5 is turned off, the voltage drop of the first driving voltage ELVDD may be reduced, and then, in case that both the fifth transistor T5 and the sixth transistor T6 are turned off, a brightness change due to a leakage current may be reduced.

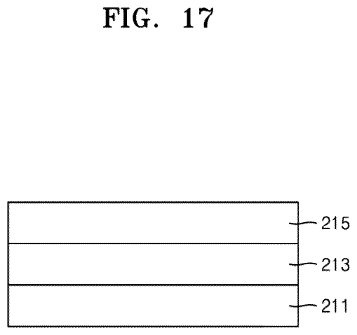

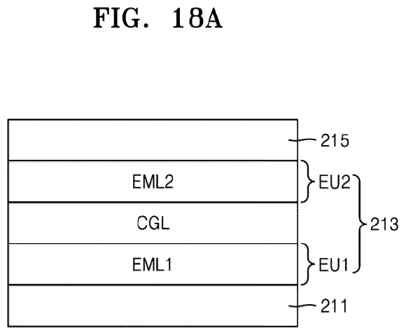

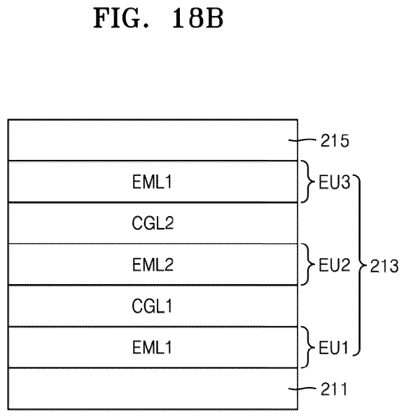

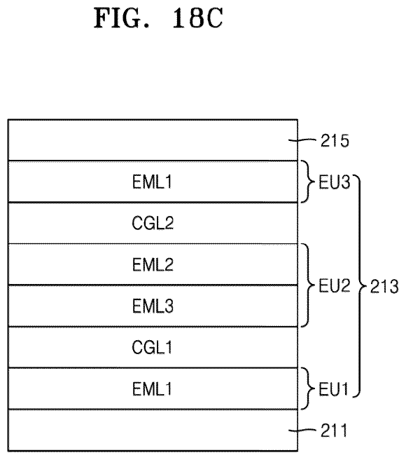

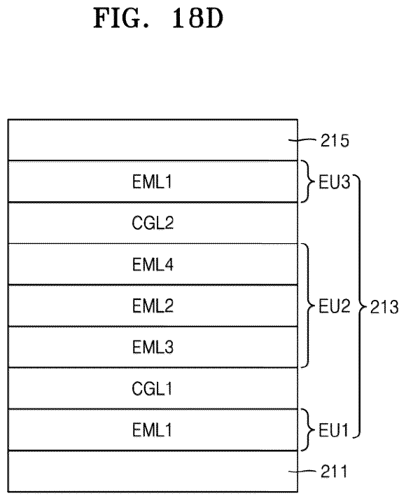

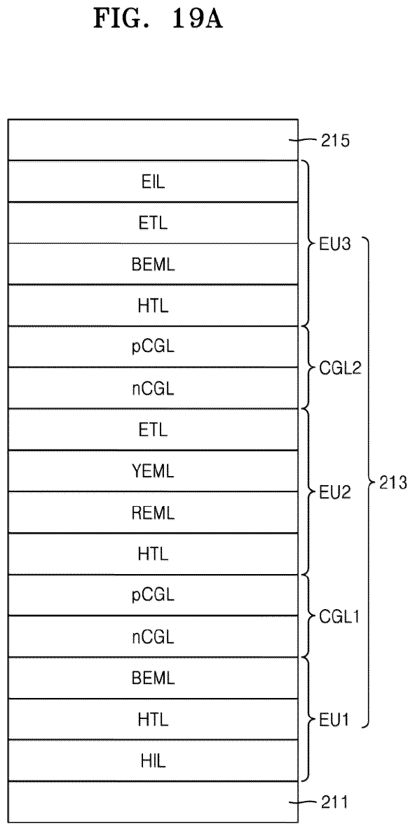

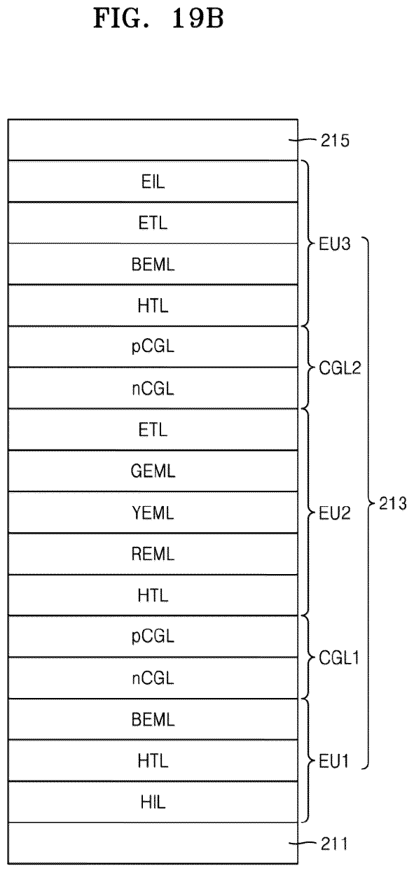

FIG. 17 is a schematic cross-sectional view of a structure of a display element according to an embodiment. FIGS. 18A to 19B are schematic cross-sectional views of a structure of a display element according to an embodiment.

Referring to FIG. 17, the organic light-emitting diode OLED, which is a display element according to an embodiment, may include a pixel electrode 211, an opposite electrode 215, and an intermediate layer 213 between the pixel electrode 211 (e.g., a first electrode, e.g., an anode) and the opposite electrode 215 (e.g., a second electrode, e.g., a cathode).

The pixel electrode 211 may include a light-transmissive conductive oxide such as indium tin oxide (ITO), indium zinc oxide (IZO), zinc oxide (ZnO), indium oxide (In₂O₃), indium gallium oxide (IGO), or aluminum zinc oxide (AZO). The pixel electrode 211 may include a reflective layer including silver (Ag), magnesium (Mg), aluminum (AI), platinum (Pt), palladium (Pd), gold (Au), nickel (Ni), neodymium (Nd), iridium (Ir), chrome (Cr), or a compound thereof. As an example, the pixel electrode 211 may have a three-layered structure of ITO/Ag/ITO.

The opposite electrode 215 may be disposed on the intermediate layer 213. The opposite electrode 215 may include a metal, alloy, electrically conductive compound, or any combination thereof having a low work function. As an example, the opposite electrode 215 may include lithium (Li), silver (Ag), magnesium (Mg), aluminum (Al), aluminum-lithium (Al—Li), calcium (Ca), magnesium-indium (Mg—In), magnesium-silver (Mg—Ag), ytterbium (Yb), silver-ytterbium (Ag—Yb), ITO, IZO, or any combination thereof. The opposite electrode 215 may be a transmissive electrode, a semi-transmissive electrode, or a reflective electrode.

The intermediate layer 213 may include a polymer organic material or a low-molecular weight organic material emitting light having a selected color. In addition to various organic materials, the intermediate layer 213 may further include metal-containing compounds such as organometallic compounds, inorganic materials such as quantum dots, and the like.

In an embodiment, the intermediate layer 213 may include an emission layer and a first functional layer and a second functional layer respectively under and on the emission layer. The first functional layer may include, for example, a hole transport layer (HTL), or include an HTL and a hole injection layer (HIL). The second functional layer may include an electron transport layer (ETL) and/or an electron injection layer (EIL). In another example, the first functional layer or the second functional layer may be omitted. The first functional layer and the second functional layer may be integrally formed to correspond to the organic light-emitting diodes OLED included in the display area DA.

In an embodiment, the intermediate layer 213 may include two or more emitting units and a charge generation layer CGL disposed between the two emitting units. For example, the two or more emitting units may be sequentially stacked between the pixel electrode 211 and the opposite electrode 215. In the case where the intermediate layer 213 includes the emitting unit and the charge generation layer, the organic light-emitting diode OLED may be a tandem light-emitting element. The organic light-emitting diode OLED may improve color purity and a light emission efficiency by having a stack structure of emitting units.

An emitting unit may include the emission layer and the first functional layer and the second functional layer respectively under and on the emission layer. The charge generation layer CGL may include a negative charge generation layer and a positive charge generation layer. A light-emission efficiency of the organic light-emitting diode OLED, which is a tandem light-emitting element including emission layers, may be enhanced even more by the negative charge generation layer and the positive charge generation layer.

The negative charge generation layer may be an n-type charge generation layer. The negative charge generation layer may supply electrons. The negative charge generation layer may include a host and a dopant. The host may include an organic material. The dopant may include a metal material. The positive charge generation layer may be a p-type charge generation layer. The positive charge generation layer may supply holes. The positive charge generation layer may include a host and a dopant. The host may include an organic material. The dopant may include a metal material.

In an embodiment, as shown in FIG. 18A, the organic light-emitting diode OLED may include a first emitting unit EU1 and a second emitting unit EU2 that are sequentially stacked. For example, the first emitting unit EU1 may include a first emission layer EML1, and the second emitting unit EU2 may include a second emission layer EML2. The charge generation layer CGL may be disposed between the first emitting unit EU1 and the second emitting unit EU2. As an example, the organic light-emitting diode OLED may include the pixel electrode 211, the first emission layer EML1, the charge generation layer CGL, the second emission layer EML2, and the opposite electrode 215 that are sequentially stacked. The first functional layer and the second functional layer may be disposed under and on the first emission layer EML1. The first functional layer and the second functional layer may be disposed under and on the second emission layer EML2. The first emission layer EML1 may be a blue emission layer, and the second emission layer EML2 may be a yellow emission layer.

In an embodiment, as shown in FIG. 18B, the organic light-emitting diode OLED may include a first emitting unit EU1, a second emitting unit EU2, and a third emitting unit EU3 that are sequentially stacked. For example, the first emitting unit EU1 may include the first emission layer EML1, and the second emitting unit EU2 may include the second emission layer EML2. A first charge generation layer CGL1 may be disposed between the first emitting unit EU1 and the second emitting unit EU2, and a second charge generation layer CGL2 may be disposed between the second emitting unit EU2 and the third emitting unit EU3. As an example, the organic light-emitting diode OLED may include the pixel electrode 211, the first emission layer EML1, the first charge generation layer CGL1, the second emission layer EML2, the second charge generation layer CGL2, the first emission layer EML1, and the opposite electrode 215 that are sequentially stacked. The first functional layer and the second functional layer may be disposed under and on the first emission layer EML1. The first functional layer and the second functional layer may be disposed under and on the second emission layer EML2. The first emission layer EML1 may be a blue emission layer, and the second emission layer EML2 may be a yellow emission layer.

In an embodiment, as shown in FIGS. 18C and 18D, in the organic light-emitting diode OLED, the second emitting unit EU2 may further include a third emission layer EML3 and/or a fourth emission layer EML4 that are in contact with (e.g., in direct contact with) the second emission layer EML2 under and/or on the second emission layer EML2 in addition to the second emission layer EML2. Here, direct contact may mean that another layer is not disposed between the second emission layer EML2 and the third emission layer EML3 and/or the second emission layer EML2 and the fourth emission layer EML4. The third emission layer EML3 may be a red emission layer, and the fourth emission layer EML4 may be a green emission layer.

As an example, as shown in FIG. 18C, the organic light-emitting diode OLED may include the pixel electrode 211, the first emission layer EML1, the first charge generation layer CGL1, the third emission layer EML3, the second emission layer EML2, the second charge generation layer CGL2, the first emission layer EML1, and the opposite electrode 215 that are sequentially stacked. In another example, as shown in FIG. 18D, the organic light-emitting diode OLED may include the pixel electrode 211, the first emission layer EML1, the first charge generation layer CGL1, the third emission layer EML3, the second emission layer EML2, the fourth emission layer EML4, the second charge generation layer CGL2, the first emission layer EML1, and the opposite electrode 215 that are sequentially stacked.

FIG. 19A is a schematic cross-sectional view showing an example of the organic light-emitting diode of FIG. 18C, and FIG. 19B is a schematic cross-sectional view showing an example of the organic light-emitting diode of FIG. 18D.

Referring to FIG. 19A, the organic light-emitting diode OLED may include the first emitting unit EU1, the second emitting unit EU2, and the third emitting unit EU3 that are sequentially stacked. A first charge generation layer CGL1 may be disposed between the first emitting unit EU1 and the second emitting unit EU2, and a second charge generation layer CGL2 may be disposed between the second emitting unit EU2 and the third emitting unit EU3. The first charge generation layer CGL1 and the second charge generation layer CGL2 may respectively include a negative charge generation layer nCGL and a positive charge generation layer pCGL.

The first emitting unit EU1 may include a blue emission layer BEML. The first emitting unit EU1 may further include a hole injection layer HIL and a hole transport layer HTL between the pixel electrode 211 and the blue emission layer BEML. In an embodiment, a P-doped layer may be further disposed between the hole injection layer HIL and the hole transport layer HTL. A P-doped layer may be formed by doping the hole injection layer HIL with P-type dopants. In an embodiment, at least one of a blue light auxiliary layer, an electron blocking layer, and a buffer layer may be further disposed between the blue emission layer BEML and the hole transport layer HTL. The blue light auxiliary layer may enhance a light emission efficiency of the blue emission layer BEML. The blue light auxiliary layer may enhance a light emission efficiency of the blue emission layer BEML by adjusting a hole charge balance. The electron blocking layer may prevent injection of electrons into the hole transport layer (HTL). The buffer layer may compensate for a resonance distance according to the wavelength of light emitted from the emission layer.

The second emitting unit EU2 may include a yellow emission layer YEML and a red emission layer REML under the yellow emission layer YEML that is in contact with (e.g., in direct contact with) the yellow emission layer YEML. The second emitting unit EU2 may further include a hole transport layer HTL between the red emission layer REML and the positive charge generation layer pCGL of the first charge generation layer CGL1, and further include an electron transport layer ETL between the yellow emission layer YEML and a negative charge generation layer nCGL of the second charge generation layer CGL2.

The third emitting unit EU3 may include a blue emission layer BEML. The third emitting unit EU3 may further include a hole transport layer HTL between the blue emission layer BEML and the positive charge generation layer pCGL of the second charge generation layer CGL2. The third emitting unit EU3 may further include an electron transport layer ETL and an electron injection layer EIL between the blue emission layer BEML and the opposite electrode 215. The electron transport layer ETL may include a single layer or a multi-layer. In an embodiment, at least one of a blue light auxiliary layer, an electron blocking layer, and a buffer layer may be further disposed between the blue emission layer BEML and the hole transport layer HTL. At least one of a hole blocking layer and a buffer layer may be further disposed between the blue emission layer BEML and the electron transport layer ETL. The hole blocking layer may prevent injection of holes into the electron transport layer (ETL).

The organic light-emitting diode OLED shown in FIG. 19B is different from the organic light-emitting diode OLED shown in FIG. 19A in the stack structure of the second emitting unit EU2, and other constructions are the same as each other. Referring to FIG. 19B, the second emitting unit EU2 may include the yellow emission layer YEML, the red emission layer REML under the yellow emission layer YEML and being in contact with (e.g., in direct contact with) the yellow emission layer YEML, and the green emission layer GEML on the yellow emission layer YEML and being in contact with (e.g., in direct contact with) the yellow emission layer YEML. The second emitting unit EU2 may further include a hole transport layer HTL between the red emission layer REML and the positive charge generation layer pCGL of the first charge generation layer CGL1, and further include an electron transport layer ETL between the green emission layer GEML and a negative charge generation layer nCGL of the second charge generation layer CGL2.

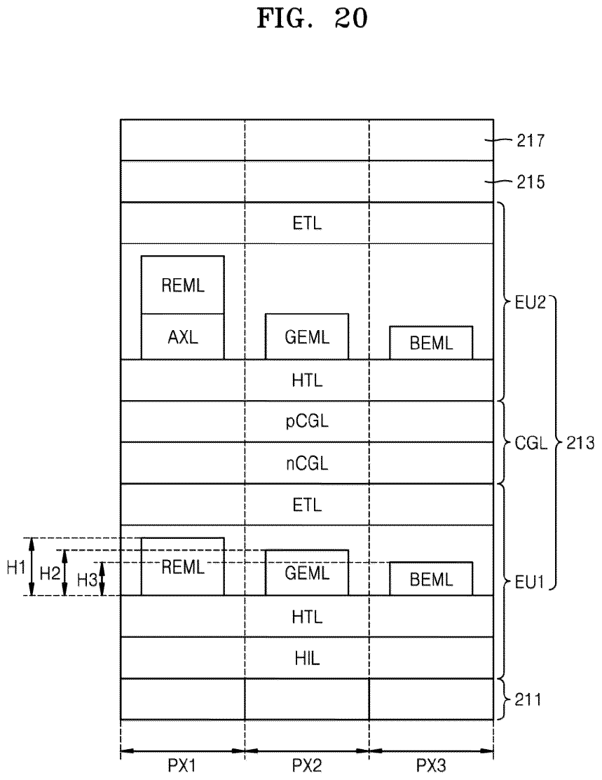

FIG. 20 is a schematic cross-sectional view of a structure of the pixel of the display apparatus according to an embodiment.

Referring to FIG. 20, the display apparatus may include pixels. The pixels may include a first pixel PX1, a second pixel PX2, and a third pixel PX3. The first pixel PX1, the second pixel PX2, and the third pixel PX3 may each include the pixel electrode 211, the opposite electrode 215, and the intermediate layer 213. In an embodiment, the first pixel PX1 may be a red pixel, the second pixel PX2 may be a green pixel, and the third pixel PX3 may be a blue pixel. Here, the pixel may include the organic light-emitting diode OLED as a display element, and the organic light-emitting diode OLED of each pixel may be electrically connected to the pixel circuit.

The pixel electrode 211 may be independently provided to each of the first pixel PX1, the second pixel PX2, and the third pixel PX3.

The intermediate layer 213 of the organic light-emitting diode OLED of each of the first pixel PX1, the second pixel PX2, and the third pixel PX3 may include the first emitting unit EU1, the second emitting unit EU2, and the charge generation layer CGL between the first emitting unit EU1 and the second emitting unit EU2. The charge generation layer CGL may include a negative charge generation layer nCGL and a positive charge generation layer pCGL. The charge generation layer CGL may be a common layer continuously formed over the first pixel PX1, the second pixel PX2, and the third pixel PX3.

The first emitting unit EU1 of the first pixel PX1 may include the hole injection layer HIL, the hole transport layer HTL, the red emission layer REML, and the electron transport layer ETL that are sequentially stacked on the pixel electrode 211. The first emitting unit EU1 of the second pixel PX2 may include the hole injection layer HIL, the hole transport layer HTL, the green emission layer GEML, and the electron transport layer ETL that are sequentially stacked on the pixel electrode 211. The first emitting unit EU1 of the third pixel PX3 may include the hole injection layer HIL, the hole transport layer HTL, the blue emission layer BEML, and the electron transport layer ETL that are sequentially stacked on the pixel electrode 211. Each of the hole injection layer HIL, the hole transport layer HTL, and the electron transport layer ETL of the first emitting units EU1 may be a common layer continuously formed over the first pixel PX1, the second pixel PX2, and the third pixel PX3.

The second emitting unit EU2 of the first pixel PX1 may include the hole transport layer HTL, an auxiliary layer AXL, the red emission layer REML, and the electron transport layer ETL that are sequentially stacked on the charge generation layer CGL. The second emitting unit EU2 of the second pixel PX2 may include the hole transport layer HTL, the green emission layer GEML, and the electron transport layer ETL that are sequentially stacked on the charge generation layer CGL. The second emitting unit EU2 of the third pixel PX3 may include the hole transport layer HTL, the blue emission layer BEML, and the electron transport layer ETL that are sequentially stacked on the charge generation layer CGL. Each of the hole transport layer HTL, and the electron transport layer ETL of the second emitting units EU2 may be a common layer continuously formed over the first pixel PX1, the second pixel PX2, and the third pixel PX3. In an embodiment, the second emitting unit EU2 of the first pixel PX1, the second pixel PX2, and the third pixel PX3 may further include at least one of the hole blocking layer and the buffer layer between the emission layer and the electron transport layer ETL.

A thickness H1 of the red emission layer REML, a thickness H2 of the green emission layer GEML, and a thickness H3 of the blue emission layer BEML may be determined according to a resonance distance. The auxiliary layer AXL is a layer added to adjust a resonance distance and may include a resonance auxiliary material. As an example, the auxiliary layer AXL and the hole transport layer HTL may include the same material.

Although it is shown in FIG. 20 that the auxiliary layer AXL is provided to only the first pixel PX1, embodiments are not limited thereto. As an example, the auxiliary layer AXL may be provided to at least one of the first pixel PX1, the second pixel PX2, and the third pixel PX3 to adjust a resonance distance of each of the first pixel PX1, the second pixel PX2, and the third pixel PX3.

The display apparatus may further include a capping layer 217 disposed on the outer surface of the opposite electrode 215. The capping layer 217 may improve a light-emission efficiency based on a constructive interference principle. Accordingly, a light extraction efficiency of the organic light-emitting diode OLED is increased, and thus, a light emission efficiency of the organic light-emitting diode OLED may be improved.

According to the embodiments, the display apparatus with an improved display quality may be provided. However, the scope of the disclosure is not limited by this effect.

In concluding the detailed description, those skilled in the art will appreciate that many variations and modifications may be made to the embodiments without substantially departing from the principles and spirit and scope of the disclosure. Therefore, the disclosed embodiments are used in a generic and descriptive sense only and not for purposes of limitation.

What is claimed is:

1. A pixel comprising:
a light-emitting element;
a first transistor connected between a first voltage line and the light-emitting element;
a second transistor connected between the first voltage line and the first transistor;
a third transistor connected between the first transistor and the light-emitting element; and
a fourth transistor connected between the light-emitting element and a second voltage line, wherein
the pixel is configured to emit light in a plurality of emission periods between a plurality of non-emission periods during one frame, and
the second transistor is turned off and the third transistor is turned on in even-numbered non-emission periods among the plurality of non-emission periods.

2. The pixel of claim 1, wherein
the pixel is configured to emit light in at least four emission periods during one frame,
the first transistor is a driving transistor,
the second transistor is a first emission control transistor,
the third transistor is a second emission control transistor, and
the fourth transistor is a reset transistor.

3. The pixel of claim 1, wherein
the fourth transistor is turned on in odd-numbered non-emission periods among the plurality of non-emission periods, and
a period in which the fourth transistor is turned on in each of the odd-numbered non-emission periods other than a first non-emission period is greater than a period in which the fourth transistor is turned on in the first non-emission period among the odd-numbered non-emission periods.

4. The pixel of claim 3, wherein, in a portion of a period in which the fourth transistor is turned on during each of the odd-numbered non-emission periods,
the second transistor is turned off, and the third transistor is turned on.

5. The pixel of claim 3, wherein, during periods other than the first non-emission period among the odd-numbered non-emission periods,
after the third transistor switches from a turned-on state to a turned-off state, the fourth transistor switches from a turned-off state to a turned-on state.

6. The pixel of claim 3, wherein
the first non-emission period includes:
a write-period in which a data signal is supplied to the pixel,
a first period in which the fourth transistor is turned on before the write-period, and
a second period in which the fourth transistor is turned on after the write-period,
the second transistor is turned off and the third transistor is turned on during a portion of the second period.

7. The pixel of claim 6, wherein the second transistor is turned off and the third transistor is turned on during the first period.

8. The pixel of claim 6, further comprising:
a fifth transistor connected between a third voltage line and a gate of the first transistor, wherein
the first non-emission period further includes a third period between the first period and the write-period, and
the fifth transistor is turned on during the first period and the third period.

9. The pixel of claim 8, wherein the second transistor is turned on and the third transistor is turned off during the third period.

10. The pixel of claim 1, further comprising:
a first capacitor connected between a gate of the first transistor and a node to which the first transistor and the third transistor are connected; and
a second capacitor connected between the first voltage line and the node.

11. A display apparatus comprising:
a plurality of pixels; and
a driving circuit that outputs gate signals to the plurality of pixels, wherein
each of the plurality of pixels includes:
a light-emitting element;
a first transistor connected between a first voltage line and the light-emitting element;
a second transistor connected between the first voltage line and the first transistor;
a third transistor connected between the first transistor and the light-emitting element; and
a fourth transistor connected between the light-emitting element and a second voltage line,
the pixel is configured to emit light in a plurality of emission periods between a plurality of non-emission periods during one frame, and
the driving circuit is configured to output a first gate signal of a gate-off voltage to the second transistor, and output a second gate signal of a gate-on voltage to the third transistor in even-numbered non-emission periods among the plurality of non-emission periods.

12. The display apparatus of claim 11, wherein
the plurality of pixels are configured to emit light in at least four emission periods during one frame,
the first transistor is a driving transistor,
the second transistor is a first emission control transistor,
the third transistor is a second emission control transistor, and
the fourth transistor is a reset transistor.

13. The display apparatus of claim 11, wherein
the driving circuit is configured to output a third gate signal of a gate-on voltage to the fourth transistor in odd-numbered non-emission periods among the plurality of non-emission periods, and
a period in which the third gate signal is a gate-on voltage in each of the odd-numbered non-emission periods other than a first non-emission period is greater than a period in which the third gate signal is a gate-on voltage in the first non-emission period among the odd-numbered non-emission periods.

14. The display apparatus of claim 13, wherein the driving circuit is configured to output a first gate signal of a gate-off voltage and a second gate signal of a gate-on voltage, in a portion of a period in which the third gate signal is a gate-on voltage during each of the odd-numbered non-emission periods.

15. The display apparatus of claim 13, wherein the driving circuit is configured to, during periods other than the first non-emission period among the odd-numbered non-emission periods, transition the second gate signal from a gate-on voltage to a gate-off voltage and output the second gate signal, and then transition the third gate signal from a gate-off voltage to a gate-on voltage and output the third gate signal.

16. The display apparatus of claim 13, wherein
the first non-emission period includes a write-period in which a data signal is supplied to the plurality of pixels, a first period in which the third gate signal is a gate-on voltage before the write-period, and a second period in which the third gate signal is a gate-on voltage after the write-period, and
the driving circuit is configured to output a first gate signal of a gate-off voltage and a second gate signal of a gate-on voltage, in a portion of the second period.

17. The display apparatus of claim 16, wherein the driving circuit is configured to output a first gate signal of a gate-off voltage and a second gate signal of a gate-on voltage during the first period.

18. The display apparatus of claim 16, wherein
each of the pixels further includes a fifth transistor connected between a third voltage line and a gate of the first transistor,
the first non-emission period further includes a third period between the first period and the write-period, and
the driving circuit is configured to output a fourth gate signal of a gate-on voltage to the fifth transistor during the first period and the third period.

19. The display apparatus of claim 18, wherein the driving circuit is configured to output a first gate signal of a gate-on voltage and a second gate signal of a gate-off voltage during the third period.

20. The display apparatus of claim 11, wherein the driving circuit is configured to change a period in which the first gate signal is a gate-on voltage and a period in which the first gate signal is a gate-off voltage, based on an emission ratio.
